(19) United States
(12) Patent Application Publication
(10) Pub. No.: US 2013/0029306 A1
(43) Pub. Date: Jan. 31, 2013

(54) Active learning system and method for game based learning and training

(71) Applicants: Ravindran Pulyassary, Kanata (CA); Ajitha T. Marath, Kanata (CA)

(72) Inventors: Ravindran Pulyassary, Kanata (CA); Ajitha T. Marath, Kanata (CA)

(21) Appl. No.: 13/522,322

(22) Filed: Jul. 14, 2012

Related U.S. Application Data
(63) Continuation-in-part of application No. PCT/CA2011/000066, filed on Jan. 21, 2011.

(51) Int. Cl. G09B 3/00

(52) U.S. Cl. 434/322

(57) ABSTRACT

An active learning system for use by at least one participant comprises a plurality of learning modules whose contents together make up a predetermined corpus of knowledge to be learned, a corresponding plurality of sets of training modules, each of the training module relating to a corresponding one of the learning modules, and rules prescribing a sequence of events constituting an editing session. The events comprise, for the or each participant, selecting at least some of said learning modules individually and successively, for each selected learning module selecting one of the set of related questions for the participant to answer, and recording progress of said at least one participant from a learning session start towards a learning session finish according to whether or not said at least one participant answers the selected ones of the set of related questions correctly.

This application claims priority from International (PCT) patent application NO. PCT/CA2011/000066, Dated 21 Jan. 2011 entitled “Active Learning system Method, Board Game and Card Games, Game Board and Playing Card for Use Therewith”. The entire contents of the application is incorporated herein by reference.

### TECHNICAL FIELD

This invention relates to an active learning system and method for game based learning and training The invention is especially applicable to game-playing systems and methods of the kind which employ a game board and playing cards, whether physical or computer-based.

Embodiments of the invention may employ a so-called Active Learning Methodology intended to facilitate learning of educational material using a competitive, performance-based, game-playing environment that may involve winning, losing, rewards, and challenges.

### BACKGROUND

In the school playgrounds students engage in various sports activities involving group participation, group discussion and group decision making to work towards a common goal, of selecting winners through processes and procedures with full of competitive spirit, challenges, accomplishments and rewards.

The same student enter the class room, sit in front of a text book, reads it alone or attending monotonous lecture from instructor as part of preparing for an examination that may be held sometime far in the future, result of which will not be known for sometime after the examination, all while isolated from fellow students with no opportunity for group engagements or group participation. This issue is further complicated by the fact that the 21st century the Net Generation children, born since the 1980s, spend lot of time in front of computers, on cell-phone or immersed in personal entertainment devices such as mp3 players or game stations. But when it is time to prepare for their studies they take a book and sit in a classroom or library and do their best to grasp the information content of the book in an isolated environment. But, beeping Computers, ringing cell phones, texting friends all are making net generation students itching to get out of the walls of a class room. A class room in which they are contemned to listen to the ever boring lecture by an educator in his/her attempt to transfuse the content of an ever ending text book in to their distracted brains. So education is at a cross roads.

Our attempt to keep students in the class room is not working. It is torpedoed by advancement of technology, the phones, music, conversation like distractions of 20th century class room is the action of 21st century class room. Conventional text book focused, class room based education is falling apart. So the question is if students are not interested in studies within the walls of the class room how to take studies to students in their active environment where they are more comfortable?

So it is time take formal education out of classroom based, text book centric 19th century settings to 21^{st} century context by facilitating learning in a competitive, performance-based, game-playing environment involving winning, losing, rewards, and challenges that promotes group participation and stimulates group discussion in a social setting.

Bringing the sportsman spirit from play ground to classrooms to make learning process a group activity that aimed at a common goal of better understanding of the learning topic, by encouraging group participation and group discussion, and group decision making with full of competitive spirit, challenges, instant accomplishment and rewards will make class room education more engaging, entertaining and exciting for the new generation of students.

This is the topic addressed in this invention by presenting a Game Based Learning and Training (GBLT) framework that is suitable for making learning/teaching process more relevant to game based learning using Tablet PCs, PDAs and other mobile computing technologies

Such a Framework has the potential to be used in a variety of learning and training situations as described in the following scenarios
(i) A University campus where small groups of students are learning advance topics in physics such as Quantum Mechanics and Relativity Theory by sitting under the shadow of a tree to play a game on their wirelessly networked PDAs that encourage them to discuss the topics to understand the concepts, ask questions, answer questions, challenge the opponents, get rewards and compete for a final win.
(ii) Medical schools where residency program participants are playing a board game to learn discuss and understand community medicine and pediatric oncology.
(iii) A military training facility in which new recruits for a space station mission are playing an online networked game with winning, loosing, challenges and rewards to learn the emergency operational procedure for an aircraft.
(iv) A regional, provincial or national championship competition in University level Physics, Chemistry, Mathematics, Economics etc sponsored by various professional organizations with attractive prize money.

“Active learning” refers to learning that involves more activity on the part of the learner than simply listening and watching. Without active learning, students may not be engaging in learning material beyond simple memorization. Active learning often emphasizes students working in cooperative and collaborative groups and requires students to take increased responsibility for their learning. A sense of competition and one's status in the group(s) encourages students to work hard. The recognition and respect that come from successful participation in an active learning session “fuel participation and invest the participants in the experience because it transforms knowledge into social capital”. Not only do participants “own” their learning because they participated actively in the process, but also ownership is worth something in a social context where one's status is derived from peer acknowledgement, i.e., by other participants. This incentive may be more powerful than grade point average or teacher approval.

Active learning lends itself to educational game-playing, using board games, playing cards or computer games. Games foster active learning and allow for interactivity, promote collaboration, peer-learning and team work, and increase motivation. They can be used to address cognitive, psychomotor and affective domains of learning and to support different learning styles. Perhaps most significantly, games respect a performance-based environment. One cannot be passive when playing a game. Learning through performance requires active discovery, analysis, interpretation, problem-solving, memory and physical activity which result in the sort of extensive cognitive process that deeply roots learning in a well-developed neural network. To some extent, this approach is followed in higher education and professional education, with the teacher or mentor providing guidance.

Known board games involving a game board, question/answer cards and player tokens/markers can generally be classified into either of two groups, namely entertainment and education, according to their primary objective, though many board games serve both purposes. As the name suggests, the primary objective of an entertainment board game is to give some entertainment to the player(s). The primary objective of an educational game, however, is to help the player(s) in their education or learning or training and uses game-playing so that the learning process is fun.

Primarily-educational board games are known to use question cards to pose questions about a selected subject and a game board to track each player's progress. Examples of such games include WO2005059865, WO2006133004, WO2009068723, WO2004077382, PCT/US2005/041261. US 2008/0284104 Each player proceeds along a prescribed path on the game board by providing correct answers to such questions, in some cases with no assistance or prompting, in other cases by selecting from a list of possible answers, i.e., multiple-choice, and so on. A player must complete the path ahead of the other players in order to win the game. A player may answer the questions based upon the player's knowledge of the selected subject, or, if that is deficient, simply make a guess. In general, any education or learning results from the players being given, and then remembering, correct answers to questions they were unable to answer based upon their knowledge of the subject when the question was posed. This includes correct answers given by, or to, other players during earlier game play. Thus, the players will improve their knowledge of the subject by assimilating the information contained in the answers they did not know before.

One example of an entertainment board game is the well-known game Trivial Pursuit™ by Hasbro S.A., Switzerland which comprises a game board and a set of playing cards containing questions about “trivia”. Replacement sets of question cards are available for different topics. As the term “trivia” implies, the questions and answers in any particular set, however, as formulated, are not constrained to a specific course of study or predetermined subject matter to be learned by the player(s).

One of the major limitation of such educational board game is that as the player progress along the game board, random cards are picked from the set of cards and random questions are asked. While players might learn from answers given during play, such learning would be incidental. Also, the questions are randomly selected, so learning is somewhat haphazard. It is impossible to define a structured learning path starting from introductory concepts, through intermediate concepts to advance concepts of the subject matter covered by the cards.

Invention described in WO2011038512 shows the other end of the spectrum of learning systems in which an entire learning system is presented for micro-training by incorporating various aspects of conventional memory testing methods like quiz. Such approach lacks the gaming spirit including group participation and group discussion, and group decision making with full of competitive spirit, challenges, instant accomplishment and rewards that could make learning and training more engaging, entertaining and exciting for the new generation of students.

There remains a need, therefore, for a game based learning and training approach that combine the gaming features associated with board games, with the structured learning and memory testing features associated with learning and training systems that will better facilitate the learning of any body of prescribed subject matter that incorporate various gaming spirit by encouraging group participation and group discussion, and group decision making with full of competitive spirit, challenges, instant accomplishment and rewards to make learning and training more engaging, entertaining and exciting for the new generation of students.

### SUMMARY OF INVENTION

An object of the present invention is to satisfy this need, at least partially, or at least provide an alternative.

According to a first aspect of the present invention, there is provided an active learning system for use by at least one participant, the system comprising a plurality of learning modules whose contents together make up a predetermined corpus of knowledge to be learned, a corresponding plurality of sets of questions and answers, each question-answer set relating to a corresponding one of the learning modules, and rules prescribing a sequence of events constituting a learning session, said events comprising, for said at least one participant, selecting at least some of said learning modules in sequence, for each selected learning module selecting one of the set of related questions for the participant to answer, and recording progress of said at least one participant from a learning session start towards a learning session finish according to whether or not said at least one participant answers the questions correctly.

According to a second aspect of the present invention, there is provided apparatus for use by participants during an active learning session, the apparatus comprising a progress chart and, for each player, a set of learning modules and a marker, the progress chart showing, for each player, a path between a start and a finish, the path to be traversed by the marker of that player as the session progresses, the set of learning modules together making up the corpus of knowledge to be learned by that participant, each learning module having associated therewith a set of questions about the corresponding learning module and either the answer to each of the questions or a link to the answer, together with a set of rules for the players to follow when conducing the active learning session.

Preferably, during design of the active learning system and apparatus, the contents of the learning modules are selected so as to comprise substantially all principal topics distributed throughout the entire corpus. Likewise, for each learning module, the questions preferably are distributed with respect to the content of that learning module, so as to reflect main items of knowledge contained therein.

Each learning module may comprise an identifier, e.g., a sequence number that associates the learning module with a respective similarly identified (numbered) one of the cells of the path to be traversed. The learning module also may have an associated information module comprising supplemental information relating to the learning module, and/or a summary. Thus, the information module may contain quick reference information on the subject matter contained in the learning module, perhaps with diagrams.

Each participant's progress may be tracked by means of a progress chart containing a path to be traversed by the participant by correctly answering at least some of said questions, progress being recorded by moving the participant's marker along the path. Chance selection means, for example one or more dice, may be used to select both the learning module and the related question to be posed to the participant. The path may be formed by a series of the cells, each representing a step along the path. The series of cells may be numbered sequentially, each cell number corresponding to a respective one of the plurality of learning modules which are numbered according to the same sequence. Selection of a particular cell by a particular participant, e.g., by rolling dice, automatically selects the corresponding learning module and question-answer set. The rules may specify that the participant's marker should not be moved to the cell, however, until the participant has correctly answered one of the questions (or a proxy or substitute question if permitted by the game rules)). The participant may simultaneously select the specific question to be posed, for example by rolling two dice at the same time, one to select the cell and the other to select the question.

The progress chart may be demarcated according to the corpus of knowledge and, preferably, is sub-divided into a series of cells to be traversed by the participant's marker between the start and finish points, each cell corresponding to a respective one of the learning modules, the participant being posed one of the set of questions associated with that learning module when selected, and to which the marker may be moved if and when the question is answered correctly.

The path may be sub-divided into segments, e.g., groups of cells/steps, each participant being required to answer correctly at least some questions corresponding to each segment. The chart then may provide for the player to record completion of each segment. For example, if the cells are arranged in a rectangular matrix, each segment might comprise one row of the matrix. A participant who correctly answered enough questions, and scored a sufficient number using the chance selection device, e.g., dice, would complete the row and use a suitable marker to indicate completion of that row before beginning at the start of the next row.

In some preferred embodiments of this aspect of the invention, especially those which are computer-based, the progress chart comprises a subset of the cells of a rectangular matrix of cells. The subset of cells may be selected to define a desired shape for the progress chart, perhaps to reflect the kind of knowledge to be learned, and/or to select a desired path configuration. Thus, selected cells may be “deactivated”, the remaining subset of “active” cells forming a desired progress chart and/or path. The selection of the subset may be done by the participant before the learning session begins, or during design of the active learning system. For example, selected cells of an 18×11 matrix might be deactivated to create a progress chart resembling the shape of the Periodic Table of Chemical Elements, the path being defined by the rows of cells.

In preferred embodiments of either aspect, the progress chart for the or each participant depicts the well-known Mendeleev Periodic Table of Elements, each cell of the path and the associated learning module corresponding to a respective one of the chemical elements. Each learning module and its associated question-answer set relate to one of those elements, and both the cell for that element and the associated learning module are identified by the atomic number of the element.

At present, the Periodic Table comprises chemical elements 1-118 (103 naturally occurring and the remainder artificial or theoretical for a total of 118. Theoretical element 117 is yet to be discovered but its properties have been predicted. Such an embodiment is particularly suitable for teaching the Periodic Table of Elements as well as chemical compounds and basic chemistry. Notwithstanding that, the same progress chart could be used with sets of learning modules that are not related to chemistry.

If the progress chart(s) is (are) to be depicted on the display screen of a computer or other electronic means, the participant may be permitted to create the progress chart from an M×N matrix of cells, by selecting some cells as “deactivated” and others as “active”, the latter depicting, for that participant, the path to be traversed during the session/game.

The rules may prescribe that, during actual play, a first participant asks a second participant a question based on the content of the learning module and evaluates the second participant's answer with reference to the correct answer given in the learning module. If the answer given by the second participant is incorrect, the first participant will read the correct answer. Not only the second participant but also the first participant, and any other participants, may take the opportunity to memorize the answer as the question may come up again during the game.

The rules may also prescribe for the first participant to create a question to ask the second participant instead of one of the questions associated with the learning module. For example, a six-sided dice may be used, but with only five questions associated with each of the learning modules. When the dice shows the number six, the first participant can create a question and ask the second participant to answer it. Creating a question in this way is also part of the learning process. Sometimes it is very hard and most often will require an understanding of the relevant topic, i.e., the learning module.

Such an active learning system and apparatus are appropriate to formal learning situations, but preferred embodiments take the form of board games with the attendant fun and participatory benefits they entail. Thus, preferred embodiments of the active learning system and method use a game board, learning modules each comprising a question-answer set, and other components, such as markers, pawns, dice and so on, together with a set of rules governing game play. The components may include tokens for influencing a participant's progress, such tokens being distributed to the participant(s) according to the rules. The contents of the learning modules together represent and define the corpus of knowledge to be learned, partially or completely, by playing the game one or more times.

The game board, learning modules and other components may be implemented as, or displayed upon, physical components; or displayed as graphics artifacts on the screen of a computer/electronic device, game playing equipment such as Nintendo™, hand-held device such as a personal digital assistant (PDA), so-called “smart phone”, and so on.

Where the learning modules are physical elements, the learning module content may be displayed on one side of a playing card and the related set of questions and answers on the opposite side. Each of the playing cards may further comprise an information module, conveniently on the same side as the set of questions and answers.

In the context of this specification, the term “information”, as in “source of information”, is intended to mean a “concrete/realized” collection of study materials and facts that may or may not be organized into a conventional source of information such as a school text book or a military training manual or a Wikipedia™ collection on the internet. In the same context, “knowledge”, as in a “corpus of knowledge”, is intended to mean the “abstract” envelope of comprehension and understanding intended (expected) to result from the acquisition and assimilation of a collection of study materials and facts, as in “high-school inorganic chemistry syllabus” or first year university physics curriculum, that may or may not be incorporated into conventional source of information such as a text book.

The corpus of knowledge to be learned by a particular participant may be mapped to a single set of learning modules. On the other hand, a corpus of knowledge pertaining to a relatively complex subject matter area may be covered by multiple sets of learning modules. During an active learning session, however, only one set of cards will be assigned to a single M×N matrix of cells on the active learning progress chart, irrespective of whether the set represents fully or partially the source of information or corresponding corpus of knowledge. Preferably, however, there will be a one-to-one match between the numbers of the learning modules in the set and the cell numbers on the active learning progress chart.

The sets of learning modules (and corpus of knowledge represented thereby) used by different participants during a learning session need not all be identical. For example, two or more sets of the learning modules may be related to the same subject, but represent different levels of knowledge of the subject, different players being asked questions based upon their respective assigned sets of learning modules, thereby allowing participants having different levels of pre-existing knowledge or learning abilities to participate in the same learning session.

Additionally or alternatively, the sets of learning modules may represent different subjects, so that the participants could participate in the same learning session while learning different subjects. For example, one participant might use a set of learning modules relating to basic mathematics, a second participant might use a set of learning modules relating to higher mathematics, another participant a set of learning modules relating to chemistry, and so on.

As a first corollary, a single participant can use this system on a physical or computer or electronic media for active learning of a single subject area or multiple subject areas during a single session. As a second corollary, multiple players using a physical setting located at a single site or using a computer or electronic media setting distributed across a networked environment can use the active learning game to learn various kinds of subject matter during a single session. Their progress charts could be similar or different.

The rules may prescribe for a review or learning period, conveniently at the beginning of the active learning session, during which the participants may attempt to assimilate the contents of one or more learning modules about which they may be asked questions when the session begins.

The learning session/game may be stopped and restarted at any time, the respective positions of the participants, for example the last cell numbers occupied by the participants' respective markers, being recorded or remembered for when the session restarts.

The tokens may enable a participant to progress more quickly, for example by skipping a number of cells. The tokens may comprise cards. Depending upon the rules, the tokens may be assigned to particular cells on the board before the session commences and may be awarded, perhaps as a “reward”, to the participant who, during the session, enters that particular cell.

In one preferred embodiment of the present invention, components for use with the active learning system/methodology include a game board, a set of playing cards, a set of dice, a set of reward tokens and a set of markers.

According to a third aspect of the invention, there is provided a game board for use in an educational game to learn about basic chemistry, specifically one or more of the Periodic Table of Elements, chemical compounds and basic chemistry, the game board comprising, for each participant/player, a depiction of the Mendeleev Table of Elements.

According to a fourth aspect of the invention, there is provided a method of creating an active learning system comprising the steps of extracting a corpus of knowledge from a selected source of information, parsing the corpus into a plurality of learning modules whose contents are to be learned, devising for each of the learning modules a set of questions about said learning modules to be answered by a participant together with a corresponding set of answers, and preparing rules specifying that during a learning session/game each player must answer correctly a selection of said questions in order to progress from a starting point to a finishing point of the learning session/game.

Preferably, the method further comprises designating cells of an M×N matrix of cells as active or inactive such that the active cells form a desired progress chart for each participant whereby that participant's prowess in correctly answering selected questions may be tracked.

The foregoing and other objects, features, aspects and advantages of the present invention will become more apparent from the following detailed description, taken in conjunction with the accompanying drawings, of preferred embodiments of the invention, which description is by way of example only.

### BRIEF DESCRIPTION OF DRAWINGS

In the drawings, identical or corresponding elements in the different Figures have the same reference numeral, where appropriate with a different suffix or subscript.

FIG. 1A illustrates aspects of the conceptual design of an educational system and method embodying this invention;

FIG. 1B illustrates different aspects of an alternative conceptual design of an educational system and method embodying this invention;

FIGS. 2A and 2B illustrate conceptually the content and layout of obverse and reverse sides, respectively, of playing cards comprising components of an educational system and method embodying this invention;

FIGS. 2C and 2D correspond to FIGS. 2A and 2B and illustrate specific examples of information printed upon the playing cards;

FIGS. 3A, 3B and 3C illustrate alternative game boards for other embodiments of the invention;

FIG. 4A is a preferred computer implementation for use when using the educational system and method to learn about chemical elements listed in the Periodic Table of Chemical Elements;

FIG. 4B is a top plan view of a preferred game board for use when using the educational system and method to learn about chemical elements listed in the Mendeleev Periodic Table of Elements;

FIGS. 5A and 5B illustrate, as an example, obverse and reverse sides of a playing card for the element uranium suitable for use with the board of FIG. 4;

FIGS. 5C and 5D illustrate obverse and reverse sides of an alternative playing card representing the element uranium but having different content from the card of FIGS. 5A and 5B;

FIGS. 6A, 6B, 6C and 6D illustrate, as examples, obverse sides of four other playing cards suitable for use with the game board of FIG. 4;

FIG. 7A is a side view of a player's marker or movable pawn for use with the game board shown in FIG. 4;

FIG. 7B is a top view of a set of (optional) game tokens for use with the game board shown in FIG. 4;

FIG. 8 illustrates an alternative embodiment of board game for two players;

FIG. 9 illustrates an active learning game board depicting four progress charts, each comprising an M×N matrix in which each cell depicts one or more items of Canada's Food Guide as developed by Health Canada;

FIG. 10 illustrates an active learning game board depicting four progress charts, each comprising four double-helix portions, representing the structure of DNA; and

FIG. 11 illustrates the logical organization of various elements and the design of the active learning system embodying the invention and using specifically a game board and learning modules/cards.

FIG. 12 illustrates the user interface components for along with the progress chart for a game based learning system based on Canada's Food Guide to teach, train and test students on healthy eating habits.

FIG. 13 illustrates the user interface components for along with the progress chart for a game based learning system based on Hawaii Tourist Guide for tourists and visitors.

FIG. 14 shows the user interface components for along with the progress chart for a game based learning system for GMAT test preparation.

FIG. 15 shows the structured learning training and testing facilitated by the present invention starting from a source of information (Intellectual property protection) that is converted into four corpus of knowledge (Patent, Trademark, copyright and industrial design). The corpus of knowledge associated with patent is converted into a set cards each consists of an information module, a training module and a learning module. Structured traversing of the information from introductory concept to advanced topics is facilitated by associating each card with a cell in the progress chart with a unique sequence number.

FIG. 16 shows the same set of cards used as part of the Trivial Pursuit Game board. Since the cards are mapped to the game board through matching, multiple cards are mapped onto same cell on the game board and thus there is no one to one mapping between the game board cell and playing card. Consequently sequential traversing of the cards from basic concepts to advance concept is not facilitated.

### DESCRIPTION OF PREFERRED EMBODIMENTS

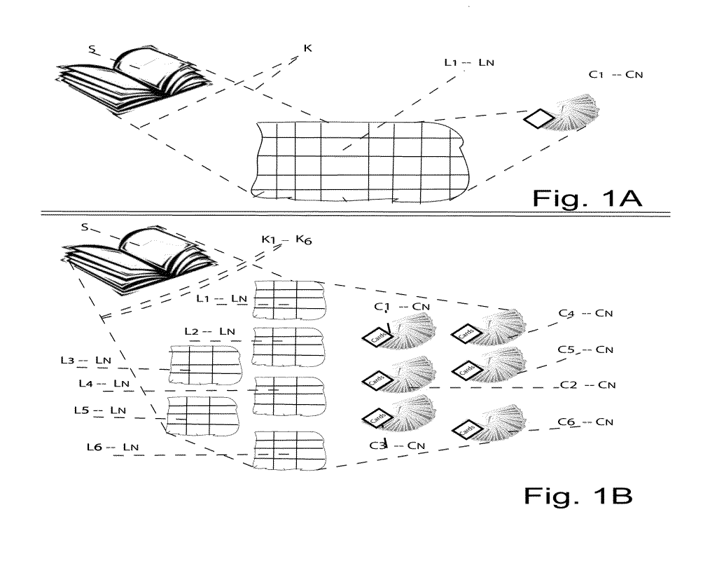

Before preferred, specific embodiments of active learning systems and methods, for example educational board games, are described, the basic concepts of embodiments of the invention and the process of designing the components of the system, including sets of learning modules for a particular corpus of knowledge to be learned, will be described with reference to FIGS. 1A and 1B.

The design of the components of the system for active learning of a particular subject starts with the identification of a source of information encompassing the corpus(es) of knowledge to be learned. Examples of such a source include, but are not limited to, traditional text books in any area of subject matter, school or academic syllabuses and course content, curricula and guides for competitive examinations like Scholastic Aptitude Test (SAT), Graduate Management Admission Test (GMAT) and Law School Admission Test LSAT and training manuals, such as the manual for operation of a fighter jet or other aircraft.

As illustrated in FIG. 1A, a corpus of knowledge K to be learned is extracted from a source of information S, for example a text book, and subdivided into snippets of information that can fit on one side of a playing card to create a set of learning modules L1-LN, where N is the number of learning modules in the set, whose contents comprise the corpus K. Each individual learning module Lₙ, is a collection of one or more fine grain learning concepts. For example, a learning card in the area of physics may contain an information module on Newton's First Law of Motion and the subsequent card may contain information on Newton's Second Law of Motion, followed by a card on Newton's Third Law of Motion. It is also possible that, in another set or sets of learning cards intended for use in a detailed learning of Physics, several cards, instead of a single card, may contain information on Newton's First Law of Motion.

A simplistic and specific example of the process for preparing a set of learning modules of the kind used in embodiments of the invention might comprise the following steps:
(i) Take a source of information such as a text book.
(ii) Copy the information content page by page to create learning modules.
(iii) Create corresponding training modules containing questions and answers based on that learning module (a specific page in the text book).
(iv) Create an information module by summarizing the page content.
(v) Assign the learning module to one side of the card and the training and information module to other side.

This simplistic process may result in an inefficient set of cards as the information content of any given page in a book may be too diluted as it is a small piece in a big puzzle organized into paragraphs, chapters and sections. A more efficient approach would be to work with the corpus of knowledge contained within the book, rather than the book itself. Thus, it is preferable to create the learning modules using the corpus of knowledge derived from these original sources of information (say the GMAT guide) rather than simply copying the GMAT book page by page onto a set of cards.

It is also preferable to create the learning modules L₁-L_{N} by sequentially “traversing” subsets of the corpus of knowledge K to systematically build the cumulative knowledge encompassed by the learning objectives of the original source of information S. Such “traversing” involves extracting the subsets or portions in an orderly fashion, according to a logical order of presentation of the discrete portions of the corpus. Such sequential traversing of subsets facilitates gradual, cumulative learning step-by-step and is used in most if not all areas of teaching and instruction. It starts with teaching of basic concepts, moving to logically connected intermediate steps which in turn lead to advanced concepts. For example: In a language curriculum for primary/elementary grade students, one sequential traversing (step-by step) approach for developing writing skills (the learning objective) would start with learning alphabets, followed by words, followed by rules of grammar and sentence structure and, finally, learning to write sentences, paragraphs and essays. All alphabets, but not necessarily all words or grammar rules, should be learned before learning to write a sentence or a paragraph. Starting with alphabets, then proceeding to words, sentence structure, grammar rules and then start writing sentences, paragraphs and essays constitutes “traversing” of the curriculum in a sequential manner. In a similar way, the designer of an active learning system decides the most suitable sequential traversing of the corpus of knowledge to create the set(s) of learning modules.

The corpus of knowledge representing a given source of information may be mapped onto a single set of playing cards for use in conjunction with a progress chart or game board. If the source of information is a particularly large book, its information may be divided into several corpuses of knowledge and a set of cards created for each corpus; in other words, a relatively extensive or complex subject matter area may be covered by a plurality of sets of playing cards.

That said, during a learning session or game play, only a single set of cards will be assigned to a single side of the game board, or to a particular participant's progress chart, irrespective of whether the set represents the corpus of knowledge fully or only partially. The only constraint at this stage is that there should be a one-to-one match between the card number and the cell number on the progress chart/game board. Thus:
(1) The number of corpuses and therefore the number of sets of playing cards depends upon the size of the information source.
(2) A simple source of information (e.g., primary school science/physics) may have only one set of cards whereas a complex source (e.g., city by-laws) may result in multiple sets of cards.
(3) The number of cards in each set of cards depends on the progress chart/game board to which these cards are assigned. For example, a 50 cell progress chart/game board requires a set of 50 cards.
(4) The number of sets used on a board depends on the layout of the game board. For example, a two-sided board, i.e., having two progress charts, will accommodate a maximum of two players (teams) whereas a six-sided board having six progress charts can accommodate a maximum of 6 players.

(5) Which sets of cards are used on each side of the progress chart/game board is a decision made by the players at the start of the play/learning session. For example, subject to the selection being acceptable to all of the players, three players can conduct a learning session using three sets of identical cards all relating to Nuclear Physics; or three sets of cards relating to school science, university physics and economics, respectively.

Once defined, each learning module Lₙ is printed on one side of a respective one of a corresponding set of playing cards C₁-C_{N}; the set of playing cards together thus represent the corpus of knowledge K extracted/derived from the original source of information S. The N cards in the set are numbered sequentially. It will be appreciated that, if the educational system and method use a computer rather than physical cards, the learning modules need not be “printed on playing cards”, but could be depicted in any convenient way. Even so, it might be preferable to show them as playing cards.

The dimensions of the playing card are appropriate to the playing medium and the learning module. For example, a hand-held card may be dimensioned so that it can be held in the hand comfortably whereas an electronic medium version of the card might have dimensions convenient to the viewing area of the electronic medium.

FIG. 1B illustrates a variation of this conceptual design. Whereas FIG. 1A illustrates a single corpus of knowledge K corresponding to a source of information S, FIG. 1B illustrates a plurality of corpuses of knowledge K₁-K_{M} identified within the single source of information S. A plurality MN of sets of learning modules are derived from these corpuses to create a corresponding plurality (M) of sets of (N) playing cards, each set corresponding to a respective one of the corpuses. For purposes of illustration and description, FIG. 1B shows six corpuses, i.e., M=6, but it will be appreciated that M could be fewer or more than six. Thus, six corpuses K1-K6 are extracted from information source S and sequentially traversed to create six sets of learning modules L1₁-L1_{N}; L2₁-L2_{N}; . . . , L6₁-L6_{N} which are printed on respective sets of playing cards C1₁-C2_{N}; C2₁-C2_{N}; . . . , C6₁-C6_{N}. The six sets of playing cards together represent the information extracted from the single source of information S. It should be noted that not all of the information of the source need be extracted. The information extracted, i.e., encompassed by the corpus(es), constitutes the knowledge to be learned.

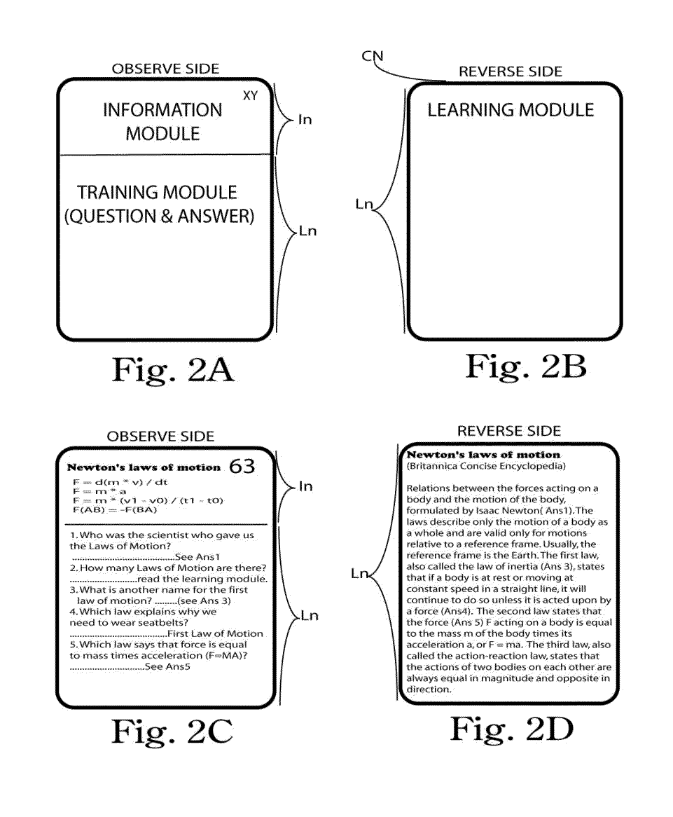

FIGS. 2A and 2B illustrate the general layout of obverse and reverse sides, respectively, of an individual one Cₙ of the playing cards and FIGS. 2C and 2D illustrate specific examples of content. Thus, FIG. 2A shows a learning module Lₙ printed on the obverse side of the playing card Cₙ and FIG. 2B shows a corresponding training module Tₙ printed on the reverse side of the playing card The training module Tₙ comprises a set of questions related to the learning module L and either the corresponding answers or links/pointers/keys to the corresponding answers (such as location/line number/paragraph number) in the learning module Lₙ. (If the system is deployed on a computer, the links or pointers could be software-based, e.g., Hypertext links).

The reverse side of the card Cₙ also carries an information module Iₙ which includes the number XY of the playing card Cₙ in the numbering sequence of the set of cards C_{1-N}. The information module Iₙ may also comprise either or both of a summary of the learning module Lₙ and additional information, such as diagrams that may be associated with and illustrate the specific topic addressed in the learning module Lₙ. As shown by way of example in FIGS. 2C and 2D, a typical playing card for active learning in the area of Physics might have printed upon its obverse side a learning module Lₙ comprising an explanation of Newton's laws of motion (FIG. 2C), and might have printed upon its reverse side (FIG. 2D) a training module Tₙ comprising a set of questions and answers about Newton's law of motion based upon the information in the learning module Lₙ, together with an information module Iₙ comprising a corresponding set of equations and the card number 63. One or more sets of playing cards of this kind can be used alone, or in conjunction with a progress chart/game board, to facilitate active learning of the corpus of knowledge.

### Board Game Version of the Preferred Embodiments

Typically, if a single participant or player is involved, a single set of playing cards may be provided, together with a single progress chart to track progress during a learning session/game. If two or more participants/players are involved, two or more sets of playing cards may be provided along with two or more progress charts, one set of playing cards and one progress chart for each player. Conveniently, the progress charts will be depicted upon a game board.

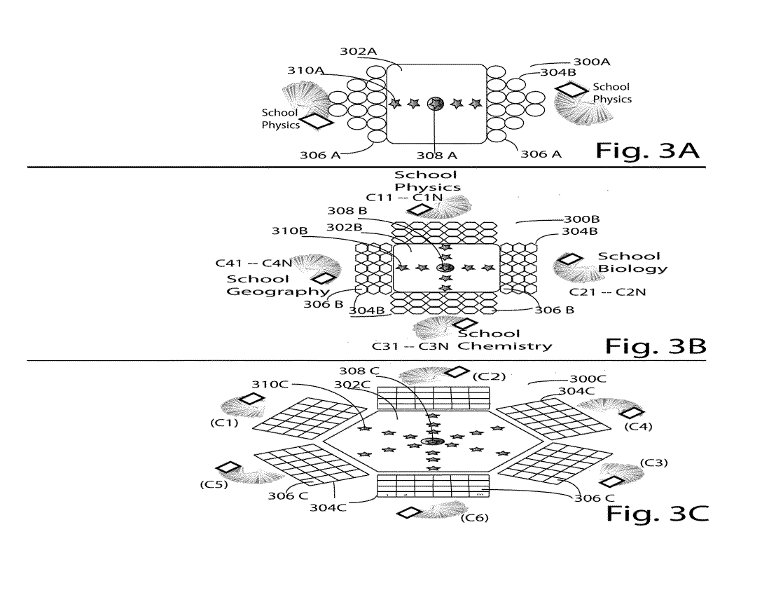

Examples of such game boards and associated sets of cards are illustrated conceptually in FIGS. 3A, 3B and 3C. All of them have in common a progress chart or table for each player. Each progress chart or table is used in monitoring the player's progress, contingent upon answering questions on the playing cards, between a starting position and a finishing position, as each player tries to be the first to reach a position where they can be given, and answer successfully, a final question, and thereby ending the game.

The progress charts may take a variety of forms, ranging from printed charts to sections of game boards to computer displays. Examples of game boards comprising progress charts each in the form of an M×N matrix for each player/participant will now be described with reference to FIGS. 3A, 3B and 3C. Each progress chart is used in monitoring the player's progress, contingent upon answering questions on the playing cards, between a starting position and a finishing position, as each player tries to be the first to reach a position where they can be given, and answer successfully, a final question, thereby ending the learning session/game.

Thus, FIG. 3A illustrates a two-player game board 300A having a rectangular central area 302A and two generally-triangular tables 304A one on each of its opposite sides, one table for each player. Each table 304A comprises a plurality of cells 306A arranged in several rows of different length, a longest row adjacent the edge of central area 302A and a shortest row furthest from the central area 302A. Two sets of playing cards C₁-C_{N} are provided, one for each player. The number (N) of cards in each set C₁-Cₙ is equal to the number of cells in each table 304A. For purposes of illustration, FIG. 3A shows 12 cells in each table 304A. It is unlikely that N would be fewer than 12 but, in practice, it may be, and probably would be, greater. In this specific example, the corpus of knowledge represented by the playing cards is School Physics and is the same for both players. It should be noted, however, that the corpuses need not be the same for both players.

In the central area 302A there is provided a star in a circle 308A representing a “winner's circle” and, between the circle 308A and each of the tables 304A, a pair of stars 310A representing intermediate positions attainable by the corresponding player upon successfully answered enough questions to progress beyond individual rows of the table of cells. More particularly, each star 310A corresponds to one row of the table 304A and a player may place a marker on the star 310A on completion of that row, by obtaining suitable scores (e.g., with a dice) to traverse the cells and answering questions selected from cards corresponding to selected cells in the row.

FIG. 3B illustrates conceptually a game board 300B for use by up to four players which, in effect, is a four-sided version of the game board 300A of FIG. 3A. In this case, each table comprises three rows of cells 306B each include an equal number of cells, specifically six. In addition, the four corpuses used by the four players, respectively, are not the same. As shown, by way of example, Player 1 has a set of playing cards C1₁-C1_{N} relating to School Physics, Player 2 has a set of playing cards C2₁-C2_{N} relating to School Biology, Player 3 has a set of playing cards C3₁-C3_{N} relating to School Chemistry and Player 4 has a set of playing cards C4₁-C4_{N} relating to School Geography.

It will be appreciated that the game board need not be rectangular, but may have any of a variety of shapes. For example, FIG. 3C illustrates conceptually a six-sided game board 300C for use by up to six players which, basically, is similar to the game boards of FIGS. 3A and 3B but with a hexagonal central area 302C and six tables 304C each containing twenty-four cells 306C in four equal rows. The six sets of playing cards shown in FIG. 3C are simply referenced C1, C2, . . . , C6 and each may represent the same corpus of knowledge as the other sets; or a different corpus. A slight variation, as compared with the game boards of FIGS. 3A and 3B, is that the game board of FIG. 3C has three sets of intermediate position stars 308C between each of the tables 302C and the centre “winner's circle” and star 308C.

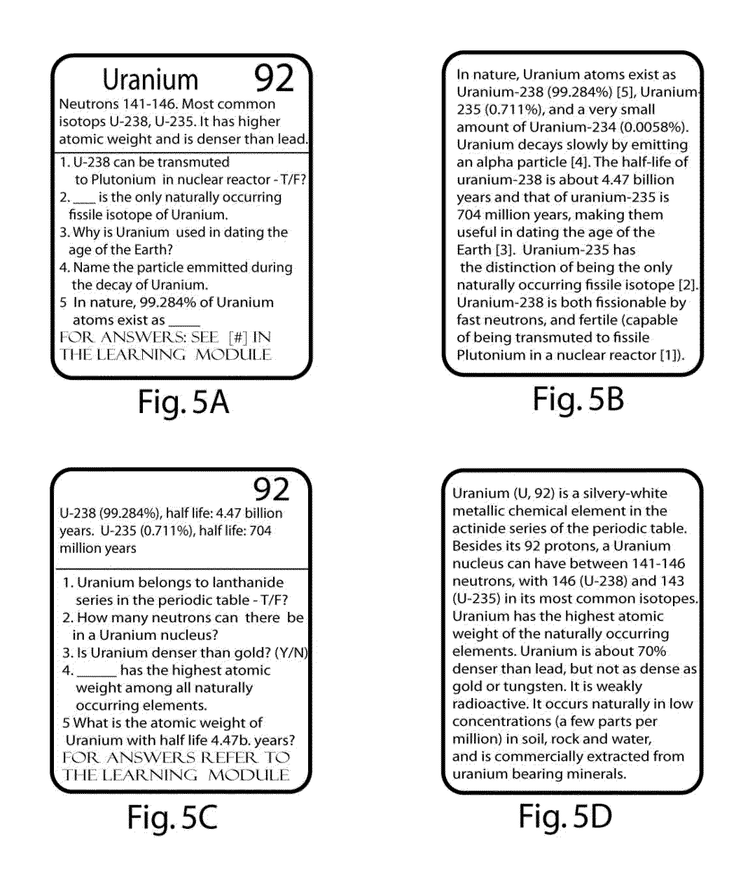

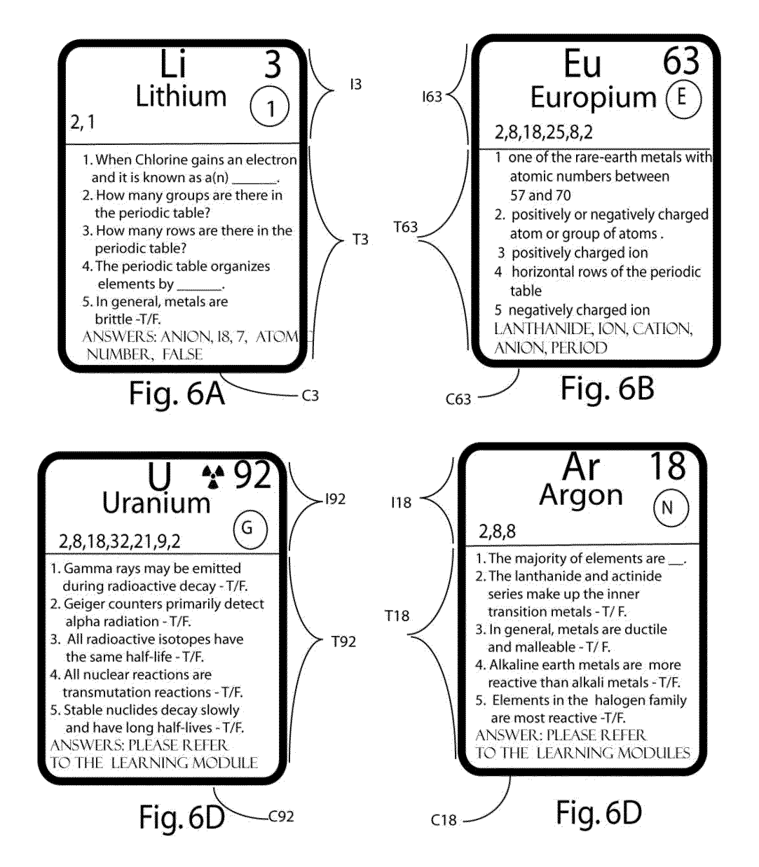

In each of the tables (M×N matrices) of the game boards of FIGS. 3A, 3B and 3C, the cells are numbered, each of the cell numbers matching a number XY on a corresponding one of the associated set of playing cards, conveniently marked on the upper right-hand corner of the card as described above with reference to FIGS. 2A and 2C (and as shown in FIGS. 5A, 5C and 6A-6D to be described later). As mentioned above, each of the intermediate position stars 310A/B/C corresponds to a row of the corresponding player's table 304A/B/C. Traversal of that row by successfully answering one or more questions may qualify the player to insert a row marker, for example a pawn playing piece, upon the corresponding intermediate position star. It should be noted that, as a general rule, the number of questions and successful answers needed to traverse a row will be fewer than the number of cells in that row, because, as will be described later, the number of cells traversed for a particular correct answer may vary. In particular, the number of cells traversed will depend upon the throw of a dice or other chance selection.

Assuming, for example, that the board has 4 rows and 18 columns and the player's first marker/pawn is on row 1, cell 16, during the player's next throw of the dice, the position dice indicates 6, the player answer the questions correctly and moves the playing piece six cells. The first row has only 18 cells, so the playing piece will be moved to cell number 22, i.e., the fourth cell of the second row (not in the 19th cell, where the second row begins) and a row marker/pawn 602 will be placed in the player's circle to indicate completion of the first row.

It should be noted that the number of intermediate stars 308A/B/C is one less than the number of rows of cells and one less than the number of markers/pawns each player will have. Once a player has positioned a marker pawn upon each intermediate position star 310A/B/C, and then has completed the final row, a successful answer in the player's next turn may enable the player to place a marker upon the “Winners circle” position star 308A/B/C and win the game, as will be described in more detail later.

It should also be noted that each of the progress charts/tables 304A/B/C could be created from a single large matrix by designating some cells as “inactive”, the remaining “active” cells forming the progress chart/table. This unique feature (with respect to prior art board games) enables the game designer to determine the configuration of the progress chart/table that is more appropriate/suitable for a given subject matter.

### Mendeleev Periodic Table of Chemical Elements Board Game (Physical Implementation)

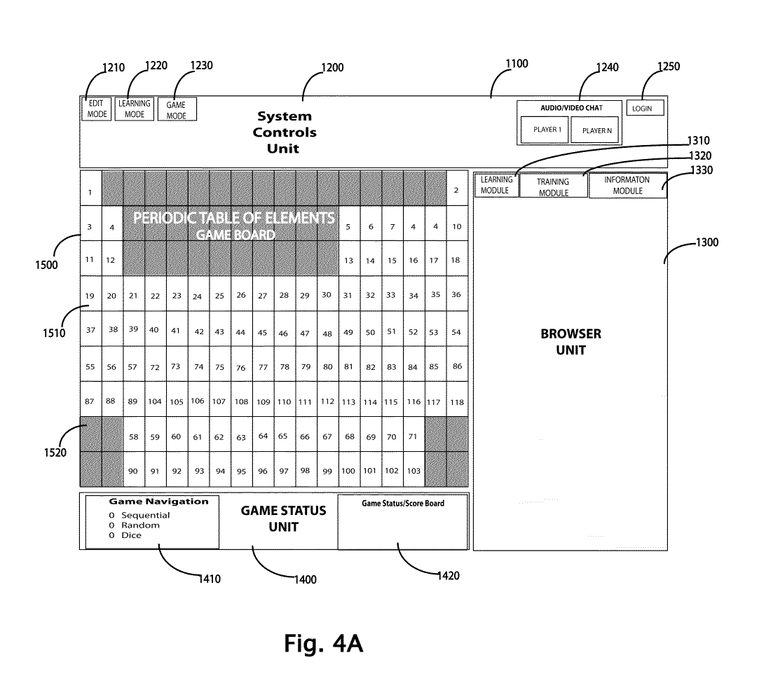

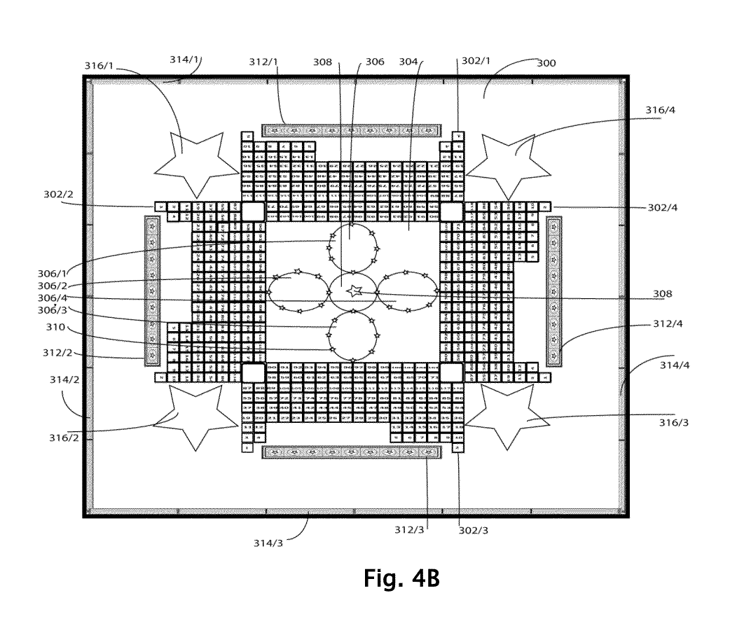

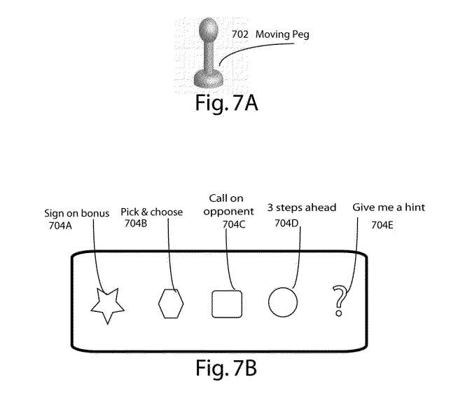

A preferred embodiment of active learning system, specifically a board game for use by up to four players learning basic chemistry, will now be described with reference to FIGS. 4, 5A-5D, 6A-6D, 7A and 7B. The board game comprises a game board 300 as shown in FIG. 4, a pair of dice or other chance selection means (not shown), a set of playing cards C₁-C_{N} (FIGS. 5A-5D and 6A-6D) per player, a set of markers (FIG. 7A) per player, and a set of rules. Optionally, the board game may include sets of reward tokens (FIG. 7B) for use if desired and agreed upon by the players before the start of the game.

The game board 300 is suitable for use by up to four players (or teams) in a learning session (game-playing session) relating to the subject area of chemistry and the Mendeleev Periodic Table of Elements. Game board 300 comprises four tables 302/1, 302/2, 302/3 and 302/4, one for each of four players 1-4, arranged around, and defining therebetween, a central rectangular play area 304. Each cell of each of the tables 302/1-302/4 is identified by a cell number in the range 1-118. It will be seen from FIG. 4 that the spatial distribution of cells in each of tables 302/1-302/4, and the numbering system used to number its individual cells, are identical to the Mendeleev Periodic Table of Elements in Chemistry. Hence, in each table the cells are arranged in nine rows. (Although element 117 has not yet been discovered, it is included because it has been named and its properties predicted.)

Four playing circles 306/1, 306/2, 306/3 and 306/4 each adjacent the middle of a respective one of the tables 302/1, 302/2, 302/3 and 302/4, are printed in central play area 304, together with a central, common “winner's” star/spot 308. Each of the playing circles 306/1, 306/2, 306/3 and 306/4 comprises eight spots 310 corresponding to the first eight rows of the associated table 302. The central winner's star/spot 308 corresponds to the ninth row of the table 302.

Linear staging areas 312/1, 312/2, 312/3 and 312/4 are provided at the outermost edges of the periodic tables 302/1, 302/2, 302/3 and 302/4, respectively, for storing each player's pawns 702. As shown in FIG. 4, each of the staging areas 312/1-312/4 has nine locations for storing the movable pawns 702. In addition, four linear card-holder strips 314/1,314/2, 314/3 and 314/4 extend along the four edge portions, respectively, of the board 300, each for use by the corresponding player. The card-holding strips 314/1, 314/2, 314/3 and 314/4 each comprise slits or grooves for holding one of the four sets of playing cards. Each player will hold in their card-holding strip 314 the set of cards of another player who is to be asked questions from that set of cards. For example, card-holding strip 314/4 along the edge of the board adjacent Player 4 will hold the playing cards of Player 1, i.e., the cards from which Player 2 will select a card to pose a question to Player 1. This assumes that play proceeds clockwise with each player being asked questions by the immediately preceding player. It is envisaged that such card holding strips might be replaced by some other means of storing the cards conveniently; or even omitted entirely.

In addition, four individual corner play areas 315/1, 315/2, 315/3 and 315/4, shown as large stars, are provided at the four corners of the board, respectively.

FIGS. 5A and 5B illustrate, as an example, obverse and reverse sides, respectively, of playing card C₉₂, i.e., for the element uranium (atomic number 92). FIGS. 5C and 5D illustrate, also as an example, obverse and reverse sides of an alternative playing card C₉₂, which also is for the element uranium. A comparison of FIG. 5B with FIG. 5D and FIG. 5A with FIG. 5C reveals that the contents of their respective learning modules differ as do the contents of their respective information modules. Accordingly, the sets of questions in their training modules differ too. These alternative playing cards would belong to different sets of playing cards which could be used during the same active learning session/board game by different players, perhaps having a different pre-existing knowledge of chemistry.

FIGS. 6A, 6B, 6C and 6D illustrate the obverse sides of four playing cards used with the game board 300. The four cards C₃, C₆₃, C₉₂ and C₁₈ are for the chemical elements lithium (Li), europium (Eu), uranium (U) and argon (Ar), respectively, listed among the elements in the tables 402 representing the Mendeleev Periodic Table of Elements. The reverse sides of the cards are not shown in FIGS. 6A-6D, but it will be understood that the reverse side of each card contains a learning module relating to the chemical element in question and upon which the questions are based and in which the answers may be found.

The obverse sides of cards C₃, C₆₃, C₉₂ and C₁₈ each carry the corresponding one of Information Modules I₃, I₆₃, I₉₂ and I₁₈ and Training Modules T₃, T₆₃, T₉₂ and T₁₈. The card numbers 3, 63, 92 and 18, respectively, are each shown at the top right corner of the card, as part of the Information Module. The Training Modules each comprise a list of five questions. The actual answers are not shown in the training module; instead, the question numbers constitute keys or pointers to the answers in the learning module on the other side of the playing card and the training module contains an indication that the answers can be found in the learning module. Thus, the learning module shown in FIG. 5B includes the numbers [1], [2] [3] [4] and [5] to identify answers to those questions. Of course, the number of questions and answers could be different, if desired.

Each of the information modules I₃, I₆₃, I₉₂ and I₁₈ contains the name, symbol, valence shell structure and atomic number of the element, along with the Column/Group, e.g., Lanthanides.

If reward tokens are used, they may be distributed to the players before play commences and used by the players during the course of play. The total number of reward tokens could vary between zero and the maximum number of active cells on each M×N matrix on the game board/progress chart; the number to be distributed during a game is a decision made by or for the players before the start of the game. In this particular example, each player will be assigned a set of the reward tokens 704. As illustrated in FIG. 7B, the reward tokens are grouped into five different sets, 704A, 704B, 704C, 704D and 704E shown identified by a star, a hexagon, a rectangle, an ellipse/circle and a question mark, respectively. The nature of each set of tokens in the context of the chemistry board game will be described later.

In addition to the pawns 702 and reward tokens 704A, 704B, 704C, 704D and 704E, chance selection means in the form of a pair of dice (not shown) are provided for use by the players. The dice are referred to as the “question” dice and the “position” dice, respectively, and are each a different colour (or otherwise distinguishable from each other). Each face of each dice has a unique number of dots, e.g., from 1 to 6. When, in his turn, a player rolls the two dice, the score on the “position” dice determines how many cells the player may advance his pawn 702 if he answers the related question correctly. The number of the cell upon which the pawn 702 will land is the number of the playing card which will be drawn and from which the question will be selected. The score on the “question” dice determines which particular question is to be selected from the list of questions on the drawn playing card.

Which of the two dice will be the “position” dice and which will be the “question” dice usually will be specified in the rules. It is envisaged, however, that more randomness might be introduced to the game by allowing the player to decide which one is the “position” dice and which one is the “question” dice after each throw. This option would be decided by the players before the start of the game.

### Playing the Game

Before play commences, each player is given nine pawns (markers) 702 an example of which is shown in FIG. 7A, a set of playing cards and, if included, a set of the (optional) reward tokens (FIG. 7B). During game play, each player uses one of the pawns 702 to mark his/her progress along the rows of the table 302. This pawn may be designated a “playing piece” and, if desired, may differ in appearance from the other eight pawns 702. Upon completion of each of the first eight rows, the player places a pawn 702 onto one of the spots 310 of the adjacent circle 306 to record completion of that row.

Once a player has completed eight rows of their table 302, all eight spots 310 of their playing circle will be occupied with pawns 702. If that player is the first to complete the ninth row of the table, upon successfully answering the final question required to complete the ninth row, they win the game and may place their “playing piece” pawn on the winner's circle star/spot 308. Placement of the movable pawns 702 on the spots 310 gives the player a sense of accomplishment as well as providing a visual overview of the state of play/progress.

Before actual game play commences, the two players each select a set of nine (9) marker pawns 702 of identical color and a respective one of two sets of 118 playing cards C1₁-C1₁₁₈ and C2₁-C2₁₁₈, i.e., equal in number to the 118 cells in each of the tables 302/1 and 302/2. The players place their sets of marker/pawns 602 in the staging areas 312/1 and 312/2, respectively, and their sets of playing cards in the holding areas 314/1 and 314/2, respectively. For quick access, the obverse sides of the playing cards displaying the information module and training module will face towards the player. If Player 1 wishes to learn physics and Player 2 wishes to learn chemistry, Player 1 will have chemistry cards in his holding area 314/1 and Player 2 will have physics cards in his holding area 314/2. If both players wish to learn chemistry, but have different pre-existing levels of knowledge of the subject, each will have a set of chemistry playing cards but the contents will be different, for example as illustrated by the playing cards shown in FIGS. 4A and 4B as compared with FIGS. 4C and 4D.

If there are more than two players, each player will hold the playing cards of the preceding player in the order of play. Thus, Player 2 will hold the playing cards of Player 1 and use them to pose questions to Player 1, Player 3 will hold the playing cards of Player 2 and use them to pose questions to Player 2, and so on.

The objective of this board game is to progress throughout all rows of the progress chart on the game board and gain the right to place the final pawn/marker 702 of the game on the winning circle star 308, thereby winning the game. The player who successfully answers enough questions to place all eight “row” pawns on the intermediate spots 310 of that player's playing circle 306 and then answers enough questions to complete the ninth row will place their ninth pawn/marker 702 on winning circle star 308.

The game can be played between two or more individuals or teams. In the case of an electronic or computer medium, the game can be played by a single player against the computer, the latter serving as the question master. For simplicity, the general procedure of playing the game between two individuals, or two teams, identified as Player 1 and Player 2, will be described below. The same board and method can be used to play the game between four players or teams.

At the start of the game, the Players each place a pawn 702 in the cell numbered 1 at the bottom left corner of the respective one of tables 302/1 and 302/2, i.e., in row 1, column 1 of the table.

To decide which player will start the game, the players throw one or more of the dice, the player throwing the higher number starting the game (as Player 1).

Player 1 starts the game by rolling the two dice in the individual corner play area 316/1 at the bottom right of periodic table 302/1. Player 2 uses the count on the position dice to determine the number of the cell to which Player 1's pawn may be moved providing Player 1 can correctly answer the selected one of the questions on the playing card having the same number as that cell. Player 2 picks from Player 1's set of playing cards C1₁ to C1_{N} the playing card having the same number as the cell, and then asks Player 1 to answer the question identified by the count of the question dice. For example, if Player 1's current position is cell number 10 and the position dice shows “4”, Player 2 selects playing card number 14. If the question dice shows “3”, Player 2 selects question 3 on playing card 14 and poses the question to Player 1. If Player 1 answers the question correctly, Player 1 moves his pawn four cells from cell 10 to new cell 14 on Player 1's table 302/1.

If Player 1 does not answer the question correctly, Player 2 clearly states the answer to the question for the benefit (edification) of Player 1, who does not move his pawn 602, which remains upon cell number 10.

It will be seen from FIGS. 4A, 4C and 5A-5D that there are only five questions on each card. If the score of the question dice is a six (6), Player 1 may get a free move to the designated cell (14) without answering a question. Alternatively, Player 1 may be required to answer a question prepared on the spot by the Player 2. These two options are available to the players to make the play easy/fast/difficult or slow. Just before the start of the game, they can decide whether they want a free move or a question created on the spot.

Player 2 continues the game by rolling the position dice and the question dice. When Player 2 is rolling the dice, cards in his area of interest are on Player 1's side of the board and therefore Player 1 picks the card and asks the question. Player 1 determines the number of the cell on Player 2's table 302/2 to which Player 2 may move their pawn 602 and selects the correspondingly-numbered playing card from the deck (set) of cards C2₁-C2_{N} comprising Player 2's subject matter. Player 1 then poses to Player 2 the question identified by the score of the question dice. If Player 2 answers the question correctly, Player 2 advances their pawn 602 from the current cell on table 302/2 to the cell identified by the count of the position dice; otherwise the pawn 602 remains on the current cell. If the score on the question dice is “6”, Player 2 may be presented with the same two options as described above.

That completes one round of the game. Player 1 starts the next round by rolling the two dice again and may or may not “land” on the same cell and thus get the same playing card from which to answer a question. Of course, for Player 1 to get both the same card and the same question on that card, both dice would have to have the same score as previously.

When a player (e.g., Player 1) is in a position to advance to a cell on table 302/1 that has the same number as the cell already occupied by another player (e.g., Player 2) on his/her table (302/2), Player 1 may challenge Player 2 to answer the question identified by the question dice from Player 1's playing card having the same number as that cell. The playing card will be from Player 1's deck of cards C1₁-CI_{N}. If Player 2 fails to answer the question, Player 2 moves his pawn backwards to a lower-numbered cell, as decided by the position dice value. For example, if the position dice score is 3, Player 2 moves his pawn back three cells.

Each time a pawn 702 of a particular player, e.g., Player 1, advances to a new row on their table 302/1, a new row marker pawn 702 is placed on a vacant spot 310 on that player's playing circle 306/1. The player, say Player 1, who has traversed all eight rows and has all eight spots 310 of playing circle 306/1 occupied by row marker pawns 702 gains access to the winning circle 308. Once Player 1's final moving pawn 702 reaches (or crosses) cell 118 in Player 1's table 302/1, i.e., the end of the ninth row, Player 1 is declared as the winner and places the final pawn 702 at the center of the winning circle 308 whereupon Player 1 will be declared the winner. It will be appreciated that there will be no question to answer because there will be no further cell number to identify a playing card from which to select the question.

The rules may prescribe that, at this stage of the game, Player 1, must obtain the exact number on the position dice to land upon cell 118. For example, if his pawn is on cell 116, he must roll a “2” and nothing else, to win the game. Alternatively, the rules may prescribe that Player 1 may obtain a score equal to or greater than the number required to land upon the last cell. It is envisaged that the rules may allow for the players to decide between these end-game options at the start of the game. Of course, exact match will make the game more interesting and challenging.

The invention is not limited to the above-described embodiments but rather encompasses various alternatives, substitution and modifications, as will now be described.

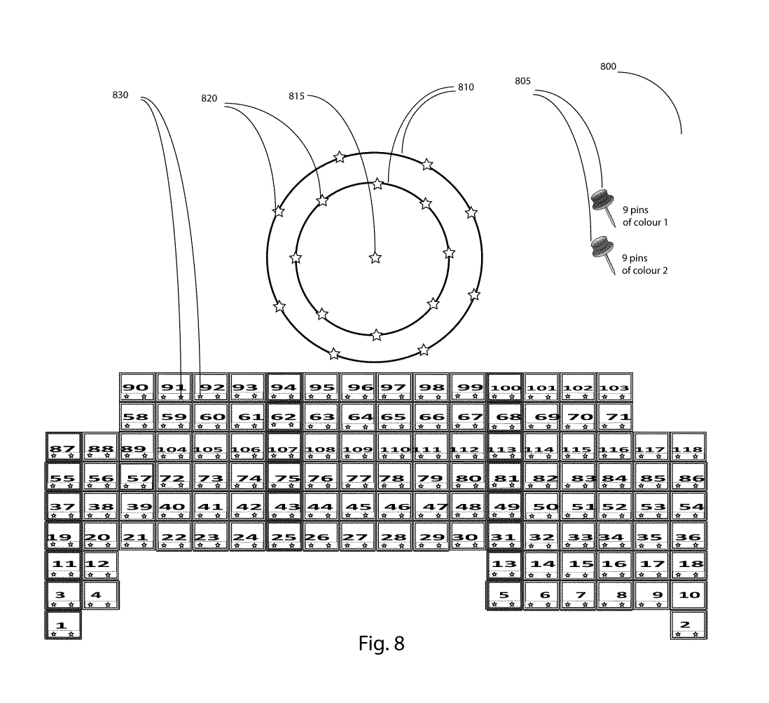

Thus, FIG. 8 shows an alternative implementation of an active learning game board (800) that can be used by two players and is readily portable. The board has a single progress chart comprising an M×N matrix whose “active” cells form a single periodic table of elements and two concentric circles 810, one for each player. In order for both players to use the same progress chart (table), each cell of the table contains two marking spots (830). The markers for indicating the progress of the two players comprise two sets of pins, each set being a different colour. The pins conveniently comprise so-called “push pins” of the kind used with cork boards or other suitable material, in which case the game board 800 may be of such a material. At the beginning of the game, each player will be assigned one set of nine pins and will insert a pin into the appropriate marking spot 830 to denote a cell on a row of the periodic table attained. Once a player has advanced across a row of the periodic table, the drawing/paper pin is moved onto a respective one of the concentric circles 810, which may be correspondingly coloured, to indicate the progress made in the game up to that moment. The player who successfully completes the ninth row, as described with respect to the other embodiments, claims victory by sticking the ninth pin into the winning spot 815 at the centre of the concentric circles.

It will be appreciated that such a shared game board having a single shared progress chart could be adapted for use by more than two players simply by adding one or more additional marking spots 830 to each cell, providing one or more additional sets markers (pins) and one or more additional circles 810. It will also be appreciated that the use of a shared progress chart is not limited to portable embodiments of the invention. Others of the above-described embodiments could use shared boards/progress charts, especially computer-based embodiments.

It is envisaged that, in any of the above-described embodiments, reward tokens could be associated with various cells on the board to encourage players and to make the playing more enjoyable. Positions and reward (value) associated with a reward token would be decided in advance, i.e., before the start of the game, by the players or by a sponsor or by a teacher who manages the play. The players could use their reward tokens to enhance their own prospects, for example by moving additional cells or obtaining help with a question, or to impair the prospects of other players, for example by obtaining one or more of their reward tokens.

For example, in one implementation one cell on each M×N matrix on the board is identified as reward cell and 4 tokens of the same kind are added into a common pool of reward tokens assigned to that cell number. When a Player moves to (their pawn lands on) that particular cell on any of the M×N matrices, the Player becomes eligible to receive a reward token (say for example 704) from the common pool of assigned tokens in the game.

Consider, for example, a two-sided version of the game board of FIG. 3 (or two players using tables at opposite sides of the four-sided board):

On each side, the third column with 4 cells (Sc/Y/La/Ac) is identified as a reward column. For each cell in the column (4 cells) on each side of the board (2 sides), a reward token is added into a common pool (2×4=8 tokens). Each time a player reaches the third column, the player transfers a reward token from the common pool to the player's personal pool. The player uses the reward token during any of the subsequent casts of the dice/subsequent rounds in that game. Once the game is finished (by identifying a winner) the reward tokens become worthless.

Some examples of the tokens, associated columns and how the tokens can be used in the game are as follows:

“Sign-on bonus” tokens 704A assigned to column 3 of each table 302. Each time when a player moves to (lands on) this column, the player earns a sign-on bonus. It is a wild card token that can be substituted for any other reward token.

“Pick and choose” tokens 704B assigned to column 6 of table 302. A player can redeem a “pick and choose” token 704B to select a card number and the question number that the player wishes to answer (rather than the question that is asked by the opposing player). The opposing player will pick the specified card from the first player's deck which will be in front of the opposing player. (Player 1 will have cards for Player 2 and Player 2 will have cards for Player 1). From an educational point of view, this reward token is introduced to encourage players to memorize the question and answer a question the player encountered in the past.

“Call an opponent” tokens 704C assigned to column 9 of table 302. If a player encounters a difficult question during the game, he/she may use one of these tokens 704C to force the opponent to answer his/her own question; the player gets a free move.

“3 steps ahead” tokens 704D assigned to column 12 of table 302. A recipient of one of these tokens may use it during any subsequent move to add three (3) to the count indicated by the position dice. For example, once a player has answered a question for a particular cell correctly, the player can use the “3 steps ahead” token to move his pawn 602 3 extra cells beyond that particular cell. The player may wait until he has answered the question and is ready to move his pawn before deciding to play the token and move the marker by the extra cells.

“Give me a hint” tokens 704E assigned to column 15 of table 302. A recipient of one of these tokens may use it during any subsequent move to get a hint for the answer from the opponent.

A player cannot use a reward token 704 in conjunction with another reward token 704, if he/she has acquired more than one reward token during a game; only one reward token 704 can be used in a given turn (round). The user of ‘round’ ‘turn’ etc is causing the confusion. More specifically, each time the dice are cast, the player may end up in a reward cell and thus may earn a reward token. The next time the dice are cast by the same player, he/she can optionally use a reward token earned previously. During a game dice are cast several times by the same player. Each time the player has the option of using a reward token (including the last winning round!) if he/she already earned one.

Once it has been played, a reward token 704 must be discarded; it cannot be used again during that game. Unused reward tokens 704 can be carried over to subsequent rounds, but cannot be carried over to subsequent games. Thus, if a player receives a reward token during round 1, he can use it during any successive round of the same game. Once the game is over reward tokens are useless for another subsequent game.

It is also envisaged that the reward tokens might be associated with specific cells, perhaps by being placed upon the cell in a manner similar to the bonus cards placed on the wheel in the popular television game Wheel of Fortune™, or by a visual link like the “Daily Double” bonuses in the television quiz game Jeopardy™. (The latter example might be more applicable to a computer-based embodiment). The person in charge of the learning session (teacher in a classroom setting, panel judge in a competition, game show host of a television version) and/or sponsors will decide how many rewards tokens are to be used, where they are to be placed on the game board, and their respective values.

It should be noted that the foregoing reward tokens are given as examples only. Any number of reward tokens of any suitable kind may be provided, though it is desirable for a player to be given a reward token only after giving a correct answer to a question. A sponsor can place a monetary reward for each cell in the game to encourage players to really master a difficult subject. As an extreme example, a wealthy teacher could motivate students to learn Einstein's special relativity theory through active learning game play by offering a reward token worth $100 on each cell on board. That said, it should be noted that, strictly speaking, the game can be played without these tokens.

The players may suspend the game at any time and, providing they remember or record their respective positions in terms of the cell number and the reward tokens earned during the game, resume it at a later time. Each moving pawn 702 defines a level in the game. Therefore, the game can be suspended/resumed at any of these levels.

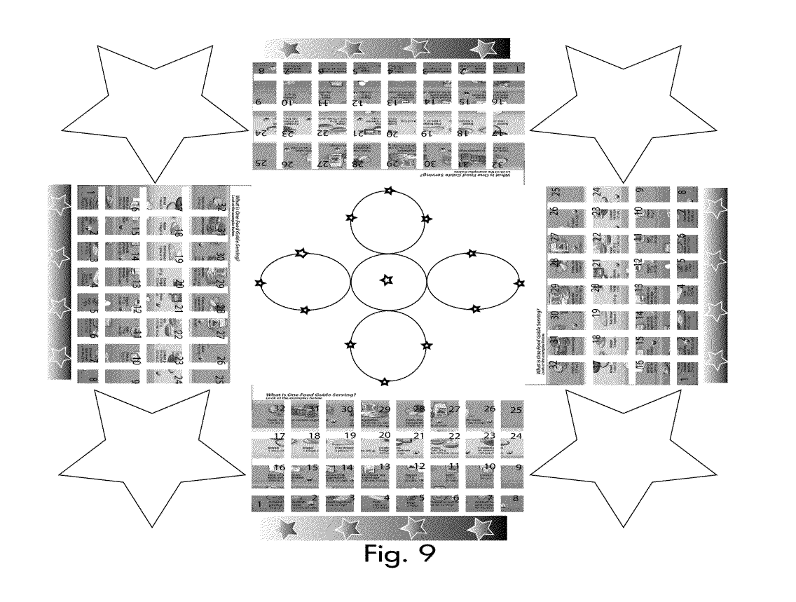

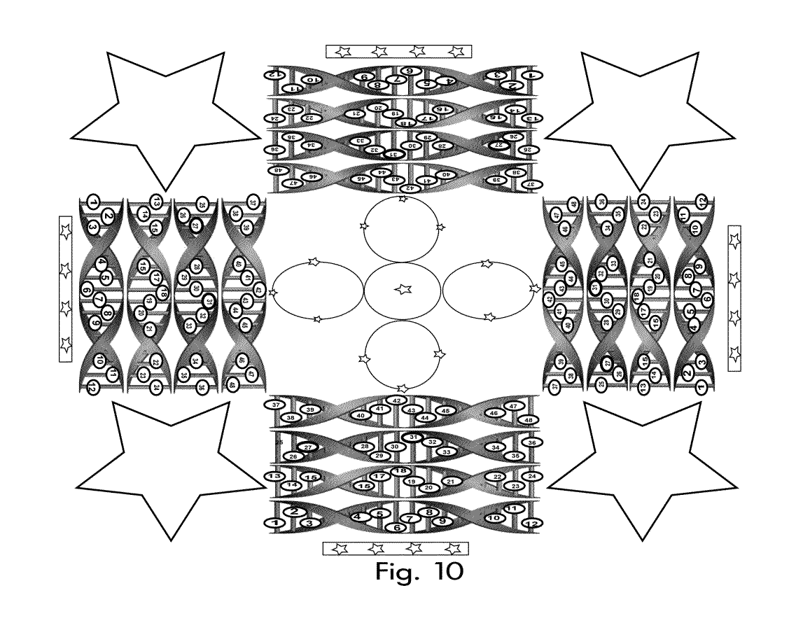

The board games described above can be used for active learning in any subject area by designing appropriate playing cards and game boards according to the basic principles described with reference to FIGS. 1A and 1B. Whereas the game board 300 described with reference to FIG. 4 has four progress charts each in the form of an 18×9 matrix having some cells “deactivated” to depict the Periodic Table of Elements, for use by up to four players learning basic chemistry, it is envisaged that the progress charts might take different configurations according to the nature of the subject matter to be learned. FIGS. 9 and 10 illustrate alternative four-person game boards that are generally similar to the game board shown in FIG. 4 but with different progress charts. Thus, FIG. 9 illustrates an alternative four-person game board in which each progress chart comprises an 8×4 matrix of which each cell depicts one or more items of Canada's Food Guide as developed by Health Canada. Such a game board might be used by players studying nutrition, for example.

FIG. 10 illustrates a four-person game board in which each progress chart comprises a 12×4 matrix of cells. In this case, the four rows of the matrix each depict a segment of a double-helix representing the structure of deoxyribonucleic acid (DNA). The 48 cells of the matrix, represented as the nucleotide links of the double-helix, are numbered 1-12, 13-24, 25-36 and 37-48, respectively. Such a game board might be used by players wishing to learn about molecular biology, for example.

It is envisaged that the components of the board game embodiments described with reference to FIGS. 4, 5A-5D, 6A-6D, 8, 9 and 10 might be supplemented; for example, additional dice may be used, as will be described later. It is also envisaged that not all of the physical components described above will need to be used; for example, the reward tokens might be omitted. Also, one or more separate progress charts, for example commonly-available charts depicting the Periodic Table of Chemical Elements, might be used instead of a game board.

It is also envisaged that the playing cards might be used to play an active learning card game for learning about the elements in the Mendeleev Table of Chemical Elements, possibly with the game board being used as a reference table, or with no game board at all, as disclosed in our International (PCT) patent application NO. PCT/CA2011/000066 The information modules of the playing cards shown in FIGS. 2C, 5A, 5C and 6A-6D could be modified so as to facilitate such use, for example by replacing the category heading “Column/Group” by special indicators, such as 1, E, G and N, respectively, in a circle and adding a “nuclear” symbol to the uranium card.

There are multiple opportunities for the players to learn or assimilate educational content during the game. Some examples are as follows:
(i) During the (optional) review phase, the players spend time reviewing the learning module at their own pace.
(ii) When a first player (Player A) asks the question and the opponent (Player B) answers the question by recollecting the information assimilated during the review phase or known beforehand.
(iii) When the first Player A compares the answer of Player B with what is given on the card.
   (iv) When Player B cannot answer the question correctly, Player A reads aloud the answer and this gives another opportunity for both players to become familiar with and perhaps assimilate at least some of the information content within the learning module.
   (v) Other indirect learning opportunities during the play may be provided by introducing bonus cards. For example, Player B may also ask Player A to replace a particular question with another question from a specific card that the player encountered previously and thereby re-confirm a question-answer pair that has already been assimilated. In order to do so, Player B will need to have, and play, a “pick and choose” token 704B.

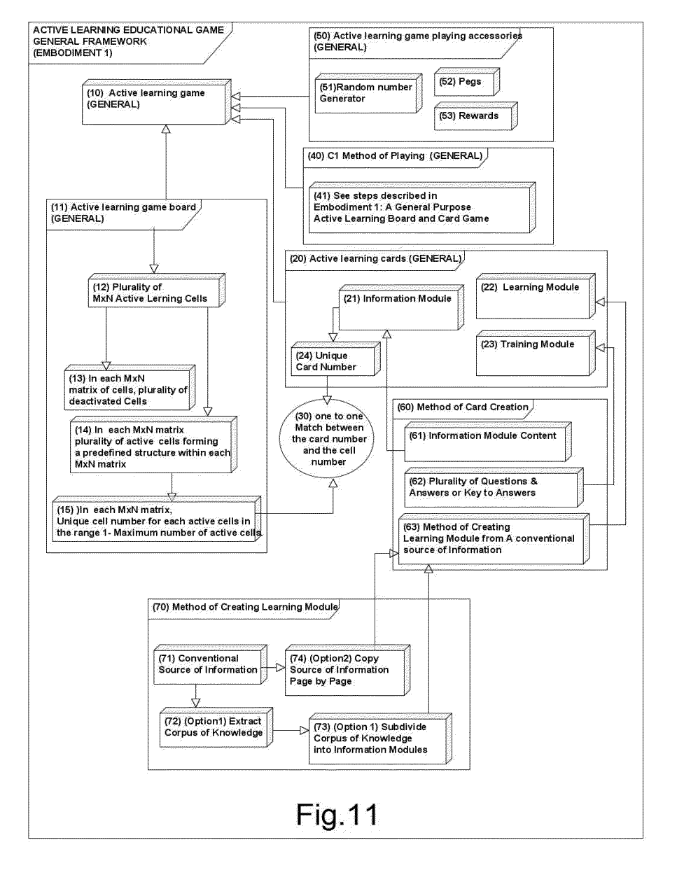

FIG. 11 illustrates the logical organization of various components of the active learning system and board game described with reference to FIGS. 1 to 10.

### Virtual Media Implementation of the Preferred Embodiment

The user interface of the Game Based Learning and Training (GBLT) Framework is shown in FIG. 1.

The GBLT user interface 1100 consists of the following components: a progress chart unit 1200 a system control unit1 1300 , a browser unit1 1400, and a status unit 1500.

### The Progress Chart Unit 1200:

The Progress Chart unit 1200 consists of a M×N matrix of cells. A unique visual representation of the serious game is mapped on to the M×N matrix by selectively deactivating some of the cells in the matrix. This visual representation may vary from one GBLT framework implementation to another depending up on the subject matter incorporated into the GBLT framework. The deactivated cells 1210 do not play any role the GBLT framework. The active cells 1220 are assigned sequence numbers identifying a unique learning path derived from the corpus of knowledge mapped on to the GBLT framework. In this specific implementation, selected cells on a 9×18 matrix are deactivated to generate a progress chart resemboling the Memdeleev's Periodic Table of Chemical Elements. A learning module, a training module and an information module are assigned to each of these cells. The cell number binds each progress chart cell to corresponding learning module, training module and information module.

### The Browser Unit 1300:

The browser unit 1300 is responsible for displaying the learning module, training module and the information module.

The learning module will be displayed under learning module tabs 1310 of the browser unit 1300. The learning module consists of any combination of audio, video, graphics, text or animation or a link (such as an html hyperlink) to content located at a remote location or a combination of the two. In the training mode the players have access to the entire content of the learning module.

The training module will be displayed under tab 1320 of the browser unit 1300. The training module consists of questions of various types including but not limited to multiple choice questions, fill in the blanks questions, true or false questions along with multi-media content to facilitate the questions. In the training mode, players have access to the entire collection of questions and corresponding correct answer within the training module.

The information module will be displayed under a separate tab 1330 of the browser unit. Players may use to the information module to store personal notes collected during the learning process. The player may keep these notes private or may publish to make it available for other players in the current of any subsequent session.

### The System Control Unit 1400:

A system control unit 1400 is responsible for controlling the operational mode of the GBLT framework. In addition it controls the players login and communication between players. There are three operational modes for the GBLT framework system: Edit mode, training mode and game mode.

In the Edit Mode, the administrator can customize the learning module, training module or information module associated with a progress chart cell by selecting the cell on the progress chart. Up on selecting, the learning module will be displayed under the learning module tabs 1310, the training module will be displayed under the training module tab 1320 and information module will be displayed under the information module tab 1330 in the browser unit 1300.

In the Edit Mode, the administrator can insert learning module consists of any combination of audio, video, graphics, text or animation for any selected cell on the progress chart or provide a link (such as a html hyperlink) to content located at a remote location. In the Edit Mode, the administrator can add the questions and correct answer to the training module and any additional notes, hints and comments to the information module that will be displayed in 1330.

In the Edit Mode, the administrator can insert or update lesson plans and helpful hints and comments to complement learning module of any cell. The information module will be displayed under the training module tab 1330 of the browser unit 1300. At any time, GBLT framwork administrator may decide to take some or all of the information modules and incorporate as part of the learning module to enhance its content.

In the edit mode, the administrator can manage sponsorship and advertisement assigned to various cells on the progress chart.

The administrator can also insert score report, rewards and winning certificates to potential winners. The administrators can manage reporting of game status and winning by various players to the players or to other stake holders.

The GBLT Framework can function either in the server mode or in the client mode by selecting the mode through the login window 1450. When GBLT framework is in the server mode, it allows other players to logon to the GBLT framework server. On the other hand, if the GBLT framework is functioning as a client, the player can logon to a remote server to participate in a serious game.

The communication control unit 1440 facilitate audio or video communication among players.

### The Navigation and Status Unit 1500:

The navigation and game status unit 1500 is responsible for selecting the desired navigation mode (random, sequential or semi-sequential) during the training and game sessions as well as to display the game score and other system status to the user.

### Editing Session (Content Delivery):

During the editing process, the administrator logs on to the GBLT framework and access the information content assigned to each progress chart cell to review the content of the learning module, training module and information module. If changes are required, the administrator make necessary changes and save the content. Administrator can also restore the original content or any of the saved versions of the game to accommodate various player groups and their background.

The administrator also manages assign sponsorships and rewards to various cells on the progress chart as well as to insert the advertisement and other relevant information provided by various sponsors of the game.

The administrator may also add or update player accounts and enable notification mechanism to store, notify or publish score and winning records.

Learning Session (Game Based Learning)

During the learning process, one or more players are logged on to the GBLT framework running in the server mode. The players can be in constant contact through audio or video chat. Players can select appropriate navigation mode to move from one cell to another depending up on the nature of the learning process. In the early stages of the learning process, player may select to move sequentially from one cell to the next. During the intermediate stages of the learning process, player may simulated decide throw to move from one cell to some random cell in the neighborhood to introduce some randomness in the learning process. Towards the advanced stages of the learning process, the players may decide to randomly select the cell for learning.

The GBLT framework player can decide the mode of navigation as well as whether to allow players to move independently from one cell to other or to synchronize the navigation among all players. Such synchronized navigation will encourage more discussion among players. On the other hand allowing players to move independently especially in the early stages of the learning process will help players to assimilate the content at their own individual phase.

During the learning process, players can select a given cell following any of the method described above and review the learning module, training module or information module and training module under the corresponding tabs in the browser unit. Players can discuss the subject matter through live audio video chat and review questions and answers as well as add comments in the information module. These comments could be kept as private, available only player who wrote it or as public available to everyone who are using the GBLT framework. Optionally, players may be exposed to messages and advertisement from the sponsors during the learning process.

### Training Session (Game Based Training)

The serious game is played one or more players against the GBLT framework itself or against other players logged on to the system. The serious game could be played in two modes. Semi Sequential Mode or Random Mode. During the serious game, questions will be displayed in the training module of the browser. The learning module will be disabled during the serious game. The information module will be available in edit mode to add new comments and notes but not to review the existing content.

In the Semi Sequential Mode, a player uses a random number generator (such as a simulated dice throw) to select a cell. If the player can answer a randomly selected question displayed in the training module tab of the browser, the player move to that cell.

If the answer is incorrect, player remains in the current position and another player take turn to select the cell, attempt to answer question and move on.

During the game, player may be exposed to advertisement and other sponsorship information inserted into the GBLT framework by the administrator.

Once a player crosses the final cell, the player can attempt to answer all questions posed to other players. Winner is selected as the one who earned maximum scores.

In the random mode of the serious game. A random number is used to select a cell on the progress chart by each player in turn, and all players can attempt to answer the question. The first person answer the question earn that spot. The game ends when all the spots are occupied or a per-defined number of spots are occupied.

Information on the game winner and players may be stored on the system for the administrator to review and to send out notification or published or notified to other stake holders. For example, to notify the course instructor about the number of attempt made by the participants and the score obtained by the participants in each session, that may be used to issue achievement certificates.

Embodiments of the present invention may employ physical media, such as paper, cardboard or plastic boards and/or playing cards. Alternatively, embodiments of the invention may be implemented using electronic media. Thus, it is envisaged that the invention might be embodied as a computer-based active learning system or game, with the various components depicted pictorially on the display screen. The term “computer-based” is intended to embrace the many kinds of device that have a computer processor and are suitable for game play, such as a personal computer (Windows/PC/Mac/Unix/Linux to list a few), gaming consoles (examples include but are not limited to Sony Playstation, Microsoft Xbox360 and Nintendo Wii) or hand-held personal communication/entertainment devices (examples including, but not limited to cell phones, IPods, Blackberries).

A computer-based version of the learning system or educational game may be played in a networked environment among multiple players located at different physical locations across the network. Embodiments of the invention are very well suited for use with/as electronic books such as Kindle™ from Amazon, either by a single player or by several players. Kindle™ permits an entire book to be uploaded and read page by page, just like regular book. Embodiments of the present invention could be uploaded to Kindle™ and then played between different players in a network environment. This is an ideal method for implementing a self-phased learning module on E-books such as Kindle™.

Embodiments of the invention can be used by a single player, perhaps as part of self-phased learning or training, using a suitably-programmed personal computer instead of another player to pose the questions and verify the answers. The type of computer may be desktop, laptop, personal digital assistant (PDA), mobile telephone (e.g. so-called “smart phone”), game console (hand-held or not), and so on. In effect, such individual-player embodiments of the invention allow the other player(s) to be replaced by the computer; a question will be displayed on the screen and its answer will be entered by the individual player and the corresponding progress across the board will be displayed.

As mentioned above, the progress chart for monitoring progression of the or each participant/player may comprise an M×N matrix. While it would be possible to use all M×N cells, it is envisaged that some of the active learning cells in the M×N matrix might be set as “inactive” (null) so that the remaining “active” (or non null) cells form a pre-defined (desired) cell distribution. For example, where M=18 and N=9, cells might be deactivated to leave a cell distribution resembling the shape of the Periodic Table of Elements shown in FIG. 4. The inactive cells will be excluded from the active learning game playing. As a general rule, however, each active cell of the M×N matrix will be assigned a sequence number and will be associated with an active set of learning module, training module and information module, depicted as a playing card or a set of browser tabs on electronic mdeia, with the same sequence number.

Where, as mentioned above, the active learning session or board game involves a non-participating person, for example a teacher, game show host, and so on, the questions might be posed by that person instead of the other, or another, player.

It should be noted that, although it is convenient to divide the progress chart into segments, each comprising a group of cells which form a row of a matrix, and record completion of a particular segment (row) by placing a marker upon the corresponding intermediate marker 308A/B/C, the progress chart might be divided into groups of cells that are not rows, and completion of each segment recorded by placing a marker 702. This is especially applicable where the matrix is not rectangular. For example, the game board may comprise concentric circles, and the groups of cells may comprise separate circles or segments of circles.

In each of the game boards of FIGS. 3A, 3B, 3C, 4A, 4b, 8, 9 and 10, the cells will be numbered, each of the cell numbers matching a number XY on a corresponding one of the associated set of playing cards, conveniently marked on the upper right-hand corner of the card as described above. In the case, where the learning module, training module and information modules are depicted as browser tabs on electronic media, these sequence number may not be visible as it is handled by the computer.

As described above, each of the intermediate position stars 310A/B/C corresponds to a row of the corresponding player's table 304A/B/C. Traversal of that row by successfully answering one or more questions may qualify the player to insert a marker, for example a pawn playing piece, upon that intermediate position star. It should be noted that, as a general rule, the number of questions and successful answers needed to traverse a row will be fewer than the number of cells in that row, because, as will be described later, the number of cells traversed for a particular correct answer may vary. In particular, the number of cells traversed will depend upon the throw of a dice or other chance selection.

Direct one-to-one mapping between a learning module and a page of conventional source of information, as mentioned above, may make the process of active learning laborious and inefficient. Thus, the game designers may derive the active learning cards from the corpus of knowledge associated with the conventional source of information rather than from the source of information itself This enable the game designer to apply editorial judgment to manipulate, resize or reformulate the corpus of knowledge inherent to a conventional source of information to make the information module more efficient and relevant to the process of active learning, without strictly adhering to a one-to-one mapping between the number of Active Learning cards (and thus the number of learning modules) and pages in the conventional source of information.

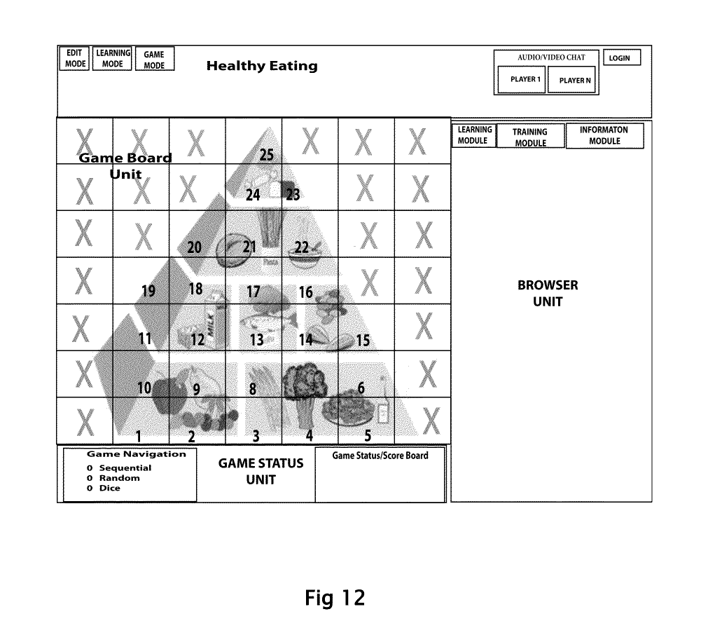

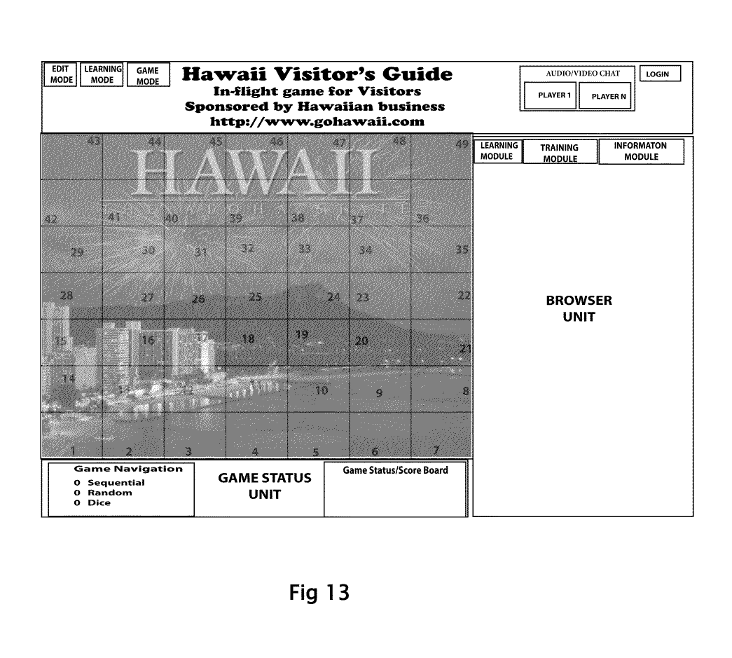

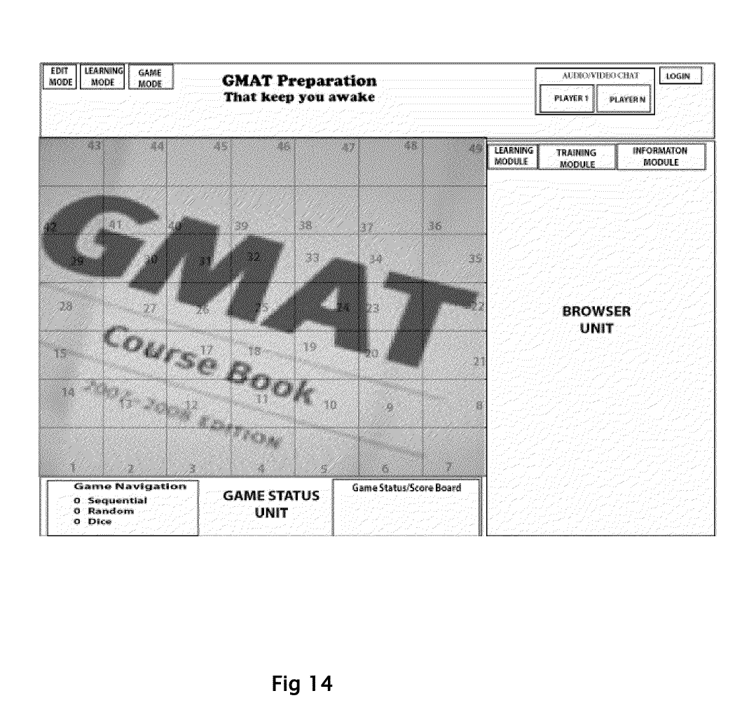

FIG. 12 shows an electronic media implementation of the invention to facilitate game based learning of healthy eating habits. FIG. 13 shows the electronic media implementation of the invention to facilitate a tourist information guide for Hawaii. FIG. 14 shows an electronic media implementation of the invention to facilitate Game Based Learning and Training for GMAT exam.

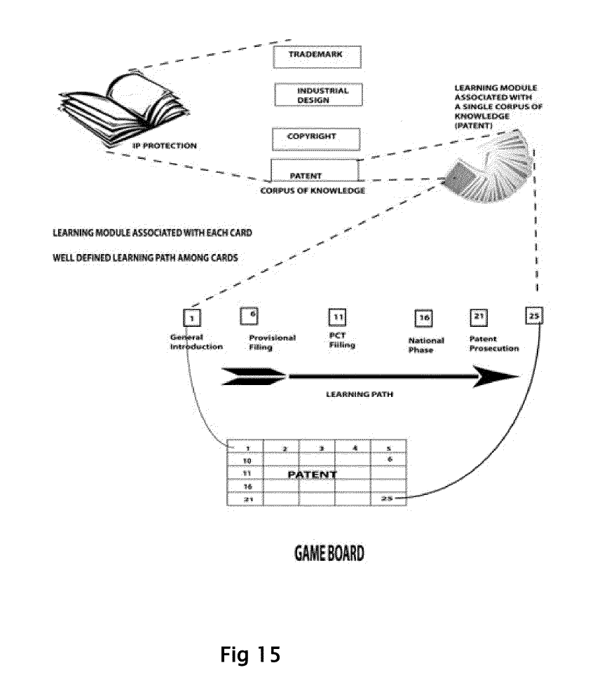

FIG. 15 shows a complete example of designing a game based learning system for training students on the subject matter related to Intellectual Property. The subject matter is divided into four corpus of knowledge as Trade mark, Industrial Design, Copyright and Patent. The corpus of knowledge associated with Patent is used to derive a set of playing cards in which each card consists of a learning module, training module and an information module and are assigned a sequence number from 1 to 25. Learning, training and information module related to introductory concepts are incorporated in cards 1-5, similar modules related to provisional patent filing, PCT filing, national entry and patent prosecution are incorporated into cards 6-10, 11-15 and 16-20, and 21-25 respectively. The progress chart (game board) consists of 5 rows of 5 cell and corresponding to each cell on the progress chart there is a unique card depicting and information module, training module and learning module. Thus by traversing sequentially, or semi sequentially along the progress chart starting from cell 1 to cell 25, the players learn or train on patent related subject matter with gradually increasing complexity, starting with introductory concepts through, provisional patenting, PCT and national phase to advanced concepts of patent prosecution.

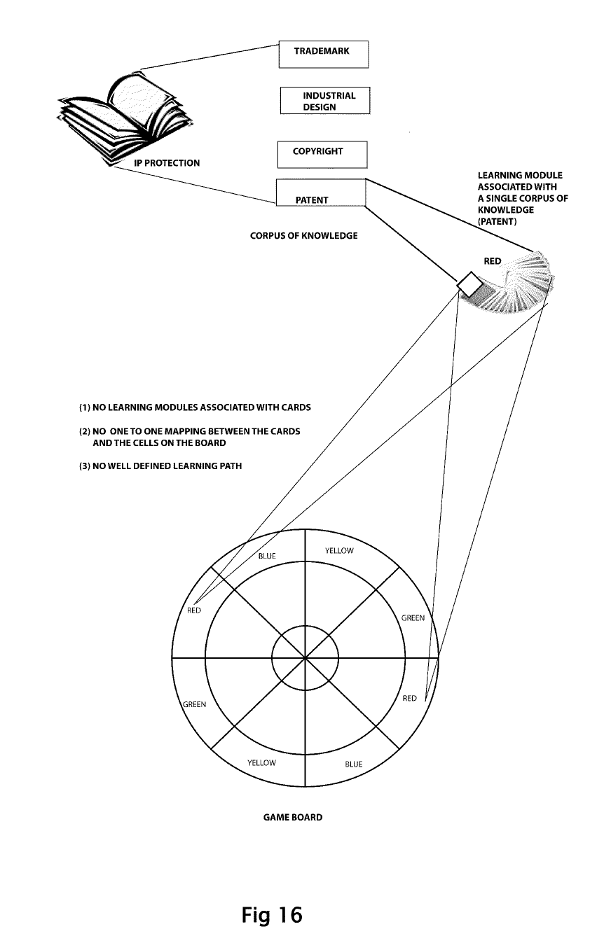

FIG. 16 shows how the same set of cards may be mapped onto a Trivial Pursuit type board game, in which the mapping between cards and cells on the game board is based on color which in turn represents a given subject matter. Since all cards are from the area of Patenting, they are assigned to same color (say red) and all the cards are mapped onto few red color cells on the game board. Thus multiple cards are mapped onto same cell and multiple cells are mapped onto any given cell. Even if the modules associated with Patent are mapped onto cards of different colours, multiple cards will assigned to multiple cells of same color on the game board. Thus, sequential learning of subject matter with gradually increasing complexity is not facilitated by the game.

In the above-described embodiments, the training modules contain the questions and either the answers or keys that will direct the player to the relevant portions in the learning module which contain the answers. When embodiments of the invention are to be used for self-training or group-training in complex subject matter areas, for example higher-mathematics or accounting, there could be situations, during the training process, in which intermediate steps taken to reach the correct solution also become as important as the final answer itself. To ensure that the intermediate steps are used/learned, the components also may comprise, for each set of cards, an answer key reference booklet containing the correct answer for each question on each card and an optional description of various steps taken to derive that answer.

Although embodiments of the invention have been described and illustrated in detail, it is to be clearly understood that the same are by way of illustration and example only and not to be taken by way of limitation, the scope of the present invention being limited only by the appended claims. CLAIMS

1. An active learning system for use by at least one participant, the system comprising:
(i) a plurality of learning modules whose contents together make up a predetermined corpus of knowledge to be learned,
(ii) a corresponding plurality of training modules each consists of a sets of questions and answers, each training module (question set) relating to a corresponding one of the learning modules,
(iii) a corresponding plurality of information module each consists of any quick reference information or user provided information,
(iv) and a progress chart to record the progress made by the participant in the use of the system,
(v) and rules prescribing a sequence of events constituting an editing session, a learning session and a training session,
(vi) having an optional editing session, during which one each of the learning, training and information modules are assigned to each cell in the progress chart
(vii) having an optional learning session start and a learning session finish, said events comprising, for said at least one participant, randomly, sequentially or semi sequentially assimilate the content of the learning modules, familiarize with training module and information module and optionally update the information module,
(viii) having a training session start and a training session finish, said events comprising, for said at least one participant, randomly, sequentially or semi sequentially selecting at least some of said training modules individually and successively, for each selected learning module selecting one of the set of related questions for the participant to answer, and recording progress of said at least one participant from a training session start towards a training session finish according to whether or not said at least one participant answers the selected ones of the set of related questions correctly

2. An active learning system according to claim 1, wherein said progress is further determined by sequentially, semi-sequentially or randomly using a chance selection means, for example, one or more dice or other random-number generating means.

3. An active learning system according to claim 1, wherein said progress is tracked by means of a progress chart demarcated according to the corpus of knowledge, the system further comprising a suitable marker for indicating the participant's current position between said starting and finishing points of the progress chart.

4. An active learning system according to claim 3, wherein said progress chart comprises a series of cells defining a path to be traversed by the participant's marker between the starting and finishing points.

5. An active learning system according to claim 1 wherein the plurality of learning modules and corresponding set of training modules and information modules are equal in number to said plurality of cells of the progress chart and each learning module, training module and information module carries an identifier linking the module with a respective one of the cells.

6. An active learning system according to claim 5, wherein said series of cells are sub-divided into groups and the progress chart further comprises, for each group, one of a plurality of spots for receiving markers to indicate traversal of the group of cells.

7. An active learning system according to claim 6, wherein said progress chart comprises at least one depiction of the Periodic Table of Chemical Elements, each cell of the progress chart corresponding to a respective one of the chemical elements, the plurality of learning modules being equal in number to the chemical elements and identified by the atomic number of a respective one of said chemical elements in said table.

8. An active learning system according to claims 1, further comprising at least one set of physical playing cards corresponding to said plurality of learning modules, each playing card bearing a respective one of said learning modules on one (reverse) side and the corresponding training module and information module on its other (obverse) side.

9. An active learning system according to claim 1, wherein the progress chart is electronic and the learning modules and related training module and information modules, with optionally user editable quick reference information, are depicted electronically as three different tabs on a electronic media browser.

10. An active learning system according to claim 5, comprising a plurality of said sets of learning modules, the content of at least one of said sets of learning modules differing from the content of the other set or sets of learning modules.

11. An active learning system according to claims 4, wherein one progress chart is configured for sharing by two or more participants, each participant using physical or virtual markers that can be distinguished from markers of the or each other participant.

12. An active learning system according to claims 1, further comprising a plurality of physical o virtual reward tokens for receipt by players during a session/game, each reward token being usable by a recipient player to affect that participant/player's progress.

13. An active learning system according to claim 12, wherein at least some of the reward tokens are each associated with a respective one of the cells and awarded to a participant/player who attains that cell.

14. A method of creating an active learning system comprising the steps of:
(i) identifying a distinct source of information;
(ii) parsing the information into a plurality of learning modules together making up a corpus of knowledge to be learned;
(iii) for each of the learning modules, devising an information modules containing quick reference information and optionally user editable content and a training modules consists of related questions derived from the learning module, to be answered by a participant during a learning session and a corresponding set of answers to the questions;
(iv) setting out rules prescribing sequences of events constituting an editing session, a learning session and a training session,
(v) having an optional editing session, during which one each of the learning, training and information modules are assigned to each cell in the progress chart
(vi) having an optional learning session start and a learning session finish, said events comprising, for said at least one participant, randomly, sequentially or semi sequentially assimilate the content of the learning modules, familiarize with training module and information module and optionally update the information module,
(vii) having a training session start and a training session finish, said events comprising, for said at least one participant, randomly, sequentially or semi sequentially selecting at least some of said training modules individually and successively, for each selected learning module selecting one of the set of related questions for the participant to answer, and recording progress of said at least one participant from a training session start towards a training session finish according to whether or not said at least one participant answers the selected ones of the set of related questions correctly.

15. An active learning method according to claim 14, wherein said progress is further determined by sequentially, semi-sequentially or randomly using a chance selection means, for example, one or more dice or other random-number generating means.

16. An active learning method according to claim 14, wherein said progress is tracked by means of a progress chart demarcated according to the corpus of knowledge, the system further comprising a suitable marker for indicating the participant's current position between said starting and finishing points of the progress chart.

17. An active learning method according to claim 14, wherein said progress chart comprises a series of cells defining a path to be traversed by the participant's marker between the starting and finishing points.

18. An active learning method according to claim 14 wherein the plurality of learning modules and corresponding set of training modules and information modules are equal in number to said plurality of cells of the progress chart and each learning module, training module and information module carries an identifier linking the module with a respective one of the cells.

19. An active learning method according to claim 14, further comprising at least one set of physical playing cards corresponding to said plurality of learning modules, each playing card bearing a respective one of said learning modules on one (reverse) side and the corresponding training module and information module on its other (obverse) side.

20. An active learning method according to claim 14, wherein the progress chart is electronic and the learning modules and related training module and information modules, with optionally user editable quick reference information, are depicted electronically as three different tabs on a electronic media browser.

21. An active learning method according to claim 14, wherein the progress chart is created from a M×N matrix of cells by designating some cells as active and other cells as inactive such that said active cells define the learning path pertaining to a specific subject matter.

22. An active learning method according to claim 21, wherein each cells on the progress chart is assigned a sequence number to bind the cell with a unique set of learning module, training module and information module with the same sequence number.
